(19) United States
(12) Patent Application Publication
(10) Pub. No.: US 2016/0299399 A1
(43) Pub. Date: Oct. 13, 2016

(54) LIQUID CRYSTAL DISPLAY DEVICE

(71) Applicant: Japan Display Inc., Minato-ku (JP)

(72) Inventor: Masakatsu KITANI, Tokyo (JP)

(73) Assignee: Japan Display Inc., Minato-ku (JP)

(21) Appl. No.: 15/091,955

(22) Filed: Apr. 6, 2016

(30) Foreign Application Priority Data
Apr. 7, 2015 (JP) 2015-078487

(51) Int. Cl. G02F 1/1362; G02F 1/1343; G09G 3/36; G02F 1/1368

(52) U.S. Cl. CPC G02F 1/136286; G02F 1/1368; G02F 1/136209; G02F 1/134363; G09G 3/3648; G09G 3/3614; G09G 3/3607; G09G 2300/0426; G09G 2300/0452; G09G 2310/027; G09G 2320/0242; G09G 2320/0626; G09G 2320/0666; G09G 2310/0294; G09G 2300/0823

(57) ABSTRACT

According to one embodiment, a liquid crystal display device includes a first substrate, a second substrate, a liquid crystal layer, a first common electrode and a second common electrode. The first substrate includes a conductive layer, a first switching element, a first signal line, a second signal line and a first pixel electrode. The first signal line forms a first electrostatic capacitive coupling with the conductive layer. The second signal line forms a second electrostatic capacitive coupling with the conductive layer. The first pixel electrode forms a third electrostatic capacitive coupling with the conductive layer. The first common electrode is opposed to the first signal line. The second common electrode is opposed to the second signal line.

### CROSS-REFERENCE TO RELATED APPLICATIONS

This application is based upon and claims the benefit of priority from Japanese Patent Application No. 2015−078487, filed Apr. 7, 2015, the entire contents of which are incorporated herein by reference.

### FIELD

Embodiments described herein relate generally to a liquid crystal display device.

### BACKGROUND

Recently, flat-panel display devices have been developed intensively; among them, liquid crystal display devices have attracted considerable attention in view of their advantages of lightness, thinness, and reduced power consumption. In particular, in an active-matrix liquid crystal display device with a switching element embedded in each pixel, a structure using a lateral electric field (including a fringe field) such as an in-plane switching (IPS) mode has been under scrutiny. Such a liquid crystal display device of the lateral electric field mode includes a pixel electrode and a counter-electrode formed on an array substrate, and switching of liquid crystal molecules is performed by a lateral electric field which is substantially parallel to the main surface of the array substrate.

In a liquid crystal display device, a voltage is applied to a liquid crystal layer, and by changing the transmissivity by changing the alignment state of the liquid crystal molecules, an image is displayed. However, when a direct-current drive which does not change the polarity of the applied voltage is adopted, the display quality of an image is reduced as the electric field distribution is varied because of the presence of impurity ions in the liquid crystal layer, for example. Accordingly, it is usual to adopt an alternating-current drive which reverses the polarity of the applied voltage at regular intervals.

As the alternating-current drive method, a frame-inversion drive scheme, a column (signal line)-inversion drive scheme, a line (scanning line)-inversion drive scheme, a dot-inversion drive scheme, etc., are known. Among the above schemes, the column-inversion drive scheme has a feature that it is effective in reducing power consumption.

### BRIEF DESCRIPTION OF THE DRAWINGS

FIG. 1 is a perspective view showing a structure of a liquid crystal display device according to a first embodiment.

FIG. 2 is an illustration showing a structure and an equivalent circuit of a liquid crystal display panel shown in FIG. 1.

FIG. 3 is an equivalent circuit of a pixel shown in FIG. 2.

FIG. 4 is a plan view showing a minimum unit structure in one pixel of the liquid crystal display panel.

FIG. 5 is a plan view showing two adjacent pixels of a plurality of pixels of the liquid crystal display panel.

FIG. 6 is a cross-sectional view showing a part of the liquid crystal display panel taken along line VI-VI of FIG. 5.

FIG. 7 is a cross-sectional view showing a part of the liquid crystal display panel taken along line VII-VII of FIG. 5.

FIG. 8 is an illustration for describing a state in which a first coupling capacitance is formed between a first signal line and a first pixel electrode shown in FIG. 5 by using a first light-shielding layer, and a second coupling capacitance is formed between a second signal line and the first pixel electrode by using the first light-shielding layer.

FIG. 9 is an illustration for describing a state in which a display area of the liquid crystal display panel is segmented into a first display area to a fifth display area.

FIG. 10 is a cross-sectional view showing a part of the liquid crystal display panel, and shows first to seventh signals lines, first to sixth pixel electrodes, a common electrode, color layers of different colors, and domains of pixels of different colors which have either positive or negative polarity.

FIG. 11A is a table showing values of voltages applied to a main common electrode and the first to sixth pixel electrodes in the second display area in an arbitrary frame period when red display is performed in the first display area, and halftone display is performed in the second to fifth display areas.

FIG. 11B is a table showing a voltage value of an image signal which drives each of the first to seventh signal lines in a scan period of the second display area, a voltage value of an image signal which drives each of the first to seventh signal lines in a scan period of the first display area, and variations in the voltage values of each of the first to seventh signal lines.

FIG. 12A is a table showing a change in the brightness caused by a leakage electric field from the first to seventh signal lines in an arbitrary frame when red display is performed in the first display area, and halftone display is performed in the second to fifth display areas, more specifically, a change in the average brightness of the pixels of different colors having either positive or negative polarity of the second display area as compared to the brightness of the halftone display.

FIG. 12B is a table showing a change in the brightness caused by a leakage electric field from the first to seventh signal lines in an arbitrary frame when red display is performed in the first display area, and halftone display is performed in the second to fifth display areas; more specifically, a change in the average brightness of the pixels of different colors of the second display area as compared to the brightness of the halftone display.

FIG. 13 is a table showing a change in the brightness caused by the leakage electric field from the first to seventh signal lines when red display, green display, blue display, cyan display, magenta display, yellow display, white display, or black display is performed in the first display area, and halftone display is performed in the second to fifth display areas; more specifically, a brightness of each of the pixels which are either positive or negative of the second display area as compared to when the halftone display is performed in an arbitrary cycle, and the average brightness of the pixels of different colors of the second display area as compared to when the halftone display is performed in the average of one cycle.

FIG. 14A is a table showing a change in the brightness caused by a coupling capacitance formed between a signal line and a pixel electrode in an arbitrary frame period when red display is performed in the first display area, and halftone display is performed in the second to fifth display areas; more specifically, a change in the average brightness of the pixels of different colors having either positive or negative polarity of the second display area as compared to the brightness of the halftone display.

FIG. 14B is a table showing a change in the brightness caused by a coupling capacitance formed between the signal line and the pixel electrode in an arbitrary frame period when red display is performed in the first display area, and halftone display is performed in the second to fifth display areas; more specifically, a change in the average brightness of the pixels of different colors of the second display area as compared to the brightness of the halftone display.

FIG. 15 is a table showing a change in the brightness caused by the coupling capacitance formed between the signal line and the pixel electrode when red display, green display, blue display, cyan display, magenta display, yellow display, white display, or black display is performed in the first display area, and halftone display is performed in the second to fifth display areas; more specifically, a brightness of each of the pixels which are either positive or negative of the second display area as compared to when the halftone display is performed in an arbitrary cycle, and the average brightness of the pixels of different colors of the second display area as compared to when the halftone display is performed in the average of one cycle.

FIG. 16 is a plan view showing a part of the liquid crystal display panel according to the first embodiment, and shows a pattern of a first light-shielding layer and a second light-shielding layer.

FIG. 17 is a plan view showing two adjacent pixels of a plurality of pixels of a liquid crystal display panel according to a second embodiment.

FIG. 18 is a cross-sectional view showing a part of the liquid crystal display panel taken along line XVIII-XVIII of FIG. 17.

FIG. 19 is an illustration for describing a state in which a first coupling capacitance is formed between a first signal line and a first pixel electrode shown in FIG. 17 by using a first conductive layer, and a second coupling capacitance is formed between a second signal line and the first pixel electrode by using a second conductive layer.

FIG. 20 is a plan view showing two adjacent pixels of a plurality of pixels of a liquid crystal display panel according to a third embodiment.

FIG. 21 is a plan view showing a part of a liquid crystal display panel according to the third embodiment, and shows a pattern of pixel electrodes and a common electrode.

### DETAILED DESCRIPTION

In general, according to one embodiment, there is provided a liquid crystal display device comprising: a first substrate including: a conductive layer; a first switching element; a first signal line and a second signal line which extend to be spaced apart from each other, the first signal line forming a first electrostatic capacitive coupling with the conductive layer, the second signal line forming a second electrostatic capacitive coupling with the conductive layer; and a first pixel electrode which is located between the first signal line and the second signal line, is electrically connected to the first signal line via the first switching element, and forms a third electrostatic capacitive coupling with the conductive layer; a second substrate arranged to be opposed to the first substrate; a liquid crystal layer held between the first substrate and the second substrate; and a first common electrode and a second common electrode both provided on at least one of the first substrate and the second substrate, the first common electrode being opposed to the first signal line and extending along the first signal line, the second common electrode being opposed to the second signal line and extending along the second signal line.

According to another embodiment, there is provided a liquid crystal display device comprising: a first substrate including: a first conductive layer; a second conductive layer; a first switching element; a first signal line and a second signal line which extend to be spaced apart from each other, the first signal line forming a first electrostatic capacitive coupling with the first conductive layer, the second signal line forming a second electrostatic capacitive coupling with the second conductive layer; and a first pixel electrode which is located between the first signal line and the second signal line, is electrically connected to the first signal line via the first switching element, forms a third electrostatic capacitive coupling with the first conductive layer, and forms a fourth electrostatic capacitive coupling with the second conductive layer; a second substrate arranged to be opposed to the first substrate; a liquid crystal layer held between the first substrate and the second substrate; and a first common electrode and a second common electrode both provided on at least one of the first substrate and the second substrate, the first common electrode being opposed to the first signal line and extending along the first signal line, the second common electrode being opposed to the second signal line and extending along the second signal line.

According to another embodiment, there is provided a liquid crystal display comprising: an insulating substrate; a first scanning line on the insulating substrate; a first signal line and a second signal line which cross the first scanning line; a first switching element which is electrically connected to the first scanning line and the first signal line, and comprises a first gate electrode and a second gate electrode; a second switching element which is electrically connected to the first scanning line and the second signal line, and comprises a third gate electrode and a fourth gate electrode; a first light-shielding layer which overlaps the first gate electrode, the second gate electrode, and the third gate electrode, and is formed in a body; and a second light-shielding layer which overlaps the fourth gate electrode, and is not connected to the first light-shielding layer.

Embodiments will be described hereinafter with reference to the accompanying drawings. The disclosure is merely an example, and proper changes within the spirit of the invention, which are easily conceivable by a skilled person, are included in the scope of the invention as a matter of course. In addition, in some cases, in order to make the description clearer, the widths, thicknesses, shapes, etc., of the respective parts are schematically illustrated in the drawings, compared to the actual modes. However, the schematic illustration is merely an example, and adds no restrictions to the interpretation of the invention. Besides, in the specification and drawings, the same elements as those described in connection with preceding drawings are denoted by like reference numbers, and a detailed description thereof is omitted unless otherwise necessary.

First, a liquid crystal display device DSP according to a first embodiment will be described in detail.

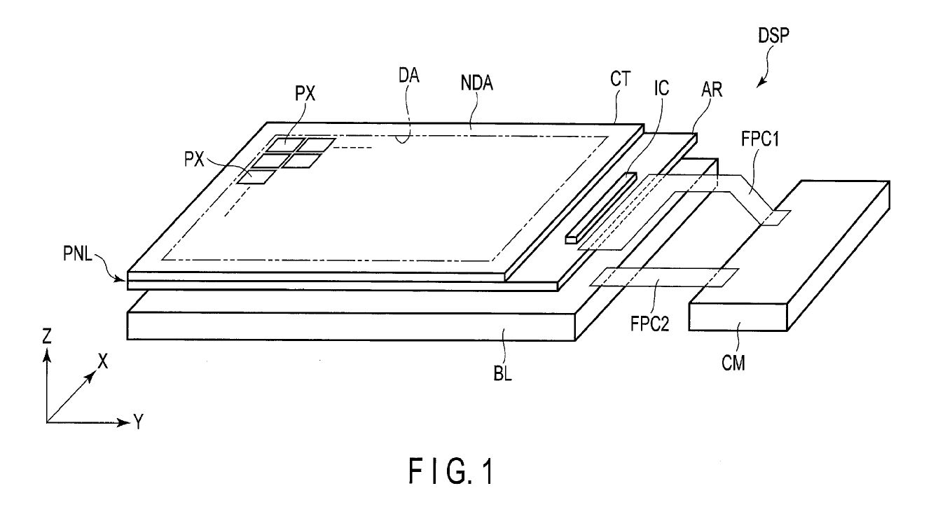

FIG. 1 is a perspective view showing a structure of the liquid crystal display device DSP according to the first embodiment. In the example depicted, a first direction X and a second direction Y are orthogonal to each other; however, they may cross each other at any angle other than 90°. A third direction Z is orthogonal to each of the first direction X and the second direction Y.

As shown in FIG. 1, the liquid crystal display device DSP comprises an active matrix type liquid crystal display panel PNL, a driver circuit IC which drives the liquid crystal display panel PNL, a backlight unit BL which illuminates the liquid crystal display panel PNL, a control module CM, flexible printed circuits FPC1 and FPC2, etc.

The liquid crystal display panel PNL includes a plate-like array substrate AR, and a plate-like counter-substrate CT arranged to be opposed to the array substrate AR with a gap. In the present embodiment, the array substrate AR serves as a first substrate and the counter-substrate CT serves as a second substrate. The liquid crystal display panel PNL includes a display area DA on which an image is displayed and a frame-shaped non-display area NDA surrounding the display area DA. The liquid crystal display panel PNL comprises a plurality of pixels PX arrayed in a matrix in the first direction X and the second direction Y within the display area DA.

A backlight unit BL is disposed on a back surface of the array substrate AR. Various types of units are applicable as the backlight unit BL, but explanation of a detailed structure of the backlight unit BL is omitted.

The driver circuit IC is mounted on the array substrate AR. The driver circuit IC is formed of an integrated circuit, for example. The flexible printed circuit FPC1 connects the liquid crystal display panel PNL and the control module CM. The flexible printed circuit FPC2 connects the backlight unit BL and the control module CM. In the present embodiment, the driver circuit IC and the control module CM constitute a driver.

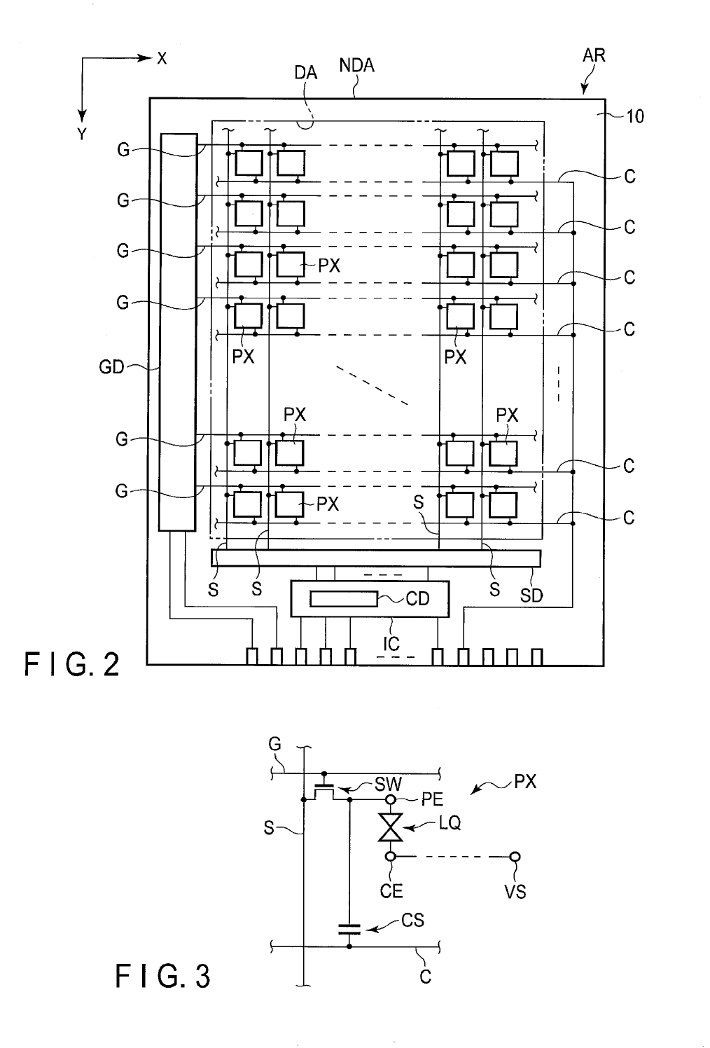

FIG. 2 is an illustration showing a structure and an equivalent circuit of the liquid crystal display panel PNL shown in FIG. 1.

As shown in FIG. 2, the liquid crystal display device DSP comprises the driver circuit IC, a scanning line driving circuit GD, a signal line driving circuit SD, etc., which are located at the non-display area NDA outside the display area DA, besides the liquid crystal display panel PNL. In the present embodiment, the signal line driving circuit SD also constitutes the driver. In the present embodiment, the driver circuit IC comprises a common electrode driving circuit CD. Note that the driver circuit IC may comprise the signal line driving circuit SD. Additionally, a multiplexer may be provided in the non-display area NDA of the array substrate AR, and signal lines may be connected to the signal line driving circuit SD via the multiplexer.

The liquid crystal display panel PNL includes a plurality of pixels PX in the display area DA. The pixels PX are arrayed in a matrix in the first direction X and the second direction Y. Also, the liquid crystal display panel PNL includes a plurality of scanning lines G, a plurality of signal lines S, and a plurality of auxiliary capacitance lines C within the display area DA.

The scanning lines G extend substantially linearly in the first direction X, and led out to the outside the display area DA, and are connected to the scanning line driving circuit GD. Also, the scanning lines G are aligned to be spaced apart from each other in the second direction Y. The signal lines S extend substantially linearly in the second direction Y, are led out to the outside of the display area DA, and are connected to the signal line driving circuit SD. In addition, the signal lines S are aligned to be spaced apart from each other in the first direction X, and cross the scanning lines G. The auxiliary capacitance lines C extend substantially linearly in the first direction X, are led out to the outside of the display area DA, and are connected to the control module CM. Also, the auxiliary capacitance lines C are aligned to be spaced apart from each other in the second direction Y. Note that the scanning lines G, the signal lines S, and the auxiliary capacitance lines C are not necessarily extended linearly, but part of them may be bent.

FIG. 3 is an equivalent circuit diagram illustrating one of the pixels PX shown in FIG. 2.

As shown in FIG. 3, each pixel PX comprises a switching element SW, a pixel electrode PE, a common electrode CE, a liquid crystal layer LQ, etc. The switching element SW is formed of, for example, a thin-film transistor. In the present embodiment, the switching element SW is formed of a top-gate thin-film transistor. The switching element SW is electrically connected to the scanning line G and the signal line S. Further, although a semiconductor layer of the switching element SW is formed of, for example, polycrystalline silicon, it may be formed of amorphous silicon or an oxide semiconductor. The pixel electrode PE is electrically connected to the switching element SW. The pixel electrode PE is opposed to the common electrode CE.

A storage capacitance CS is formed, for example, between the auxiliary capacitance line C and the pixel electrode PE. The pixel electrode PE is disposed in each pixel PX. The common electrode CE is provided within the display area DA, and is disposed in common to the pixels PX. The common electrode CE is electrically connected to the common electrode driving circuit CD. The pixel electrode PE and the common electrode CE as described above are each formed of a conductive material having light transmissivity, such as indium tin oxide (ITO) and indium zinc oxide (IZO), but they may be formed of some other metal materials such as aluminum.

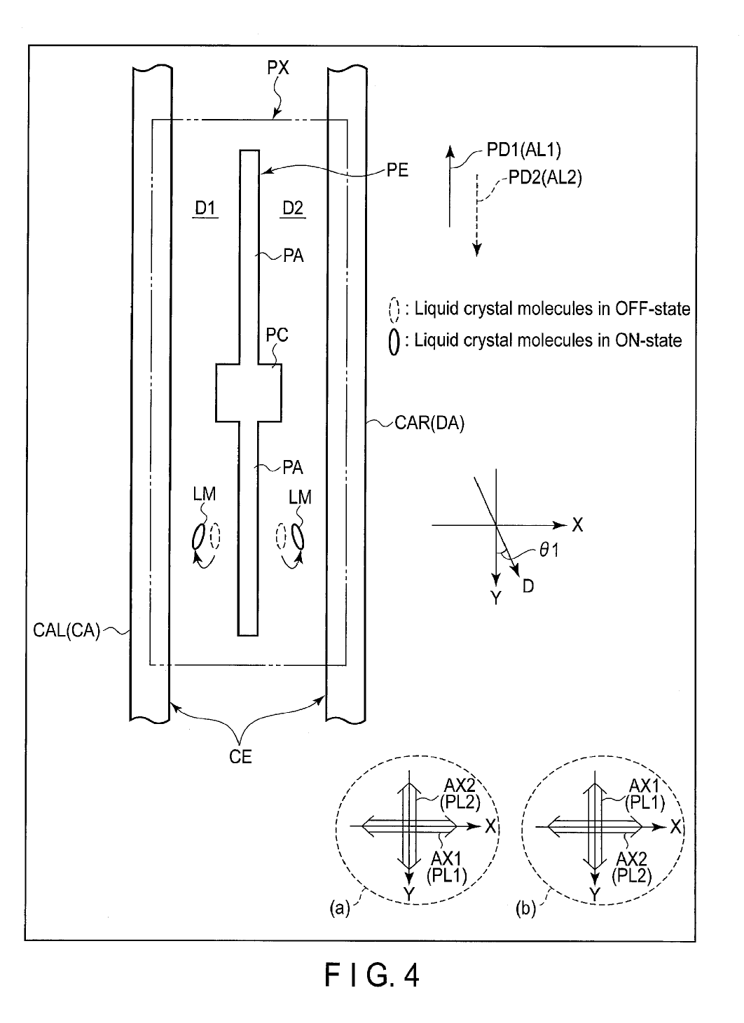

FIG. 4 is a plan view showing a minimum unit structure in one pixel of the liquid crystal display panel PNL.

As shown in FIG. 4, the pixel PX corresponds to an area depicted by a two-dot chain line in the drawing, and has a rectangular shape whose length in the second direction Y is greater than that in the first direction X. In the present embodiment, the pixel PX has a long axis parallel to the second direction. However, the pixel PX is not limited to this embodiment, and it suffices that the pixel PX has a long axis parallel to the first direction X or the second direction Y.

The pixel electrode PE includes a main pixel electrode PA extending in the direction along the long axis of each of the pixels PX. In the present embodiment, the main pixel electrode PA is formed extending in the second direction Y. Also, in the present embodiment, the pixel electrode PE includes the main pixel electrode PA and a contact portion PC which are electrically connected to each other. The main pixel electrode PA linearly extends in the second direction Y from the contact portion PC to the vicinity of an upper end portion of the pixel PX, and to the vicinity of a lower end portion of the same. More specifically, the main pixel electrode PA is formed extending linearly in the second direction Y at a substantially central portion of the pixel. The main pixel electrode PA as described above is formed in a band shape having a substantially uniform width in the first direction X. The contact portion PC is formed to be wider than the main pixel electrode PA.

The common electrode CE is disposed on at least one of the substrates of the array substrate AR and the counter-substrate CT. In the present embodiment, the common electrode CE is disposed on the array substrate AR. The common electrode CE includes a plurality of main common electrodes CA. These main common electrodes CA are electrically connected to each other. The common electrode CE is electrically insulated from the pixel electrode PE.

Liquid crystal molecules included in the liquid crystal layer LQ are switched by mainly using an electric field produced between the pixel electrode PE and the common electrode CE. The electric field, which is produced between the pixel electrode PE and the common electrode CE, is an electric field slightly inclined to an X-Y plane defined by the first direction X and the second direction Y or to a substrate main surface (or is a lateral electric field substantially parallel to the substrate main surface).

The main common electrode CA extends in the second direction Y. In the example illustrated, the main common electrode CA is formed in a band shape extending linearly in the second direction Y. Further, the main common electrodes CA are aligned in parallel to be spaced apart from each other in the first direction X. In the following, in order to distinguish between the main common electrodes CA, the left main common electrode in the drawing will be referred to as CAL, and the right main common electrode in the drawing will be referred to as CAR. In the present embodiment, the main common electrode CAL serves as a first common electrode, and the main common electrode CAR serves as a second common electrode.

The main common electrode CAL and the main common electrode CAR are each disposed between adjacent pixels in the first direction X. That is, the main common electrode CAL is disposed to extend over a boundary between the illustrated pixel PX and a pixel on the left (not shown), and the main common electrode CAR is disposed to extend over a boundary between the illustrated pixel PX and a pixel on the right (not shown).

The main common electrodes CA are disposed such that the main pixel electrode PA is interposed therebetween. That is, the main pixel electrode PA and the main common electrode CA are alternately arranged in the first direction X. These main pixel electrode PA and main common electrode CA are arranged substantially parallel to each other. At this time, in the X-Y plane, none of the main common electrodes CA overlaps the main pixel electrode PA, and an aperture which mainly contributes to display is formed between each one of the main common electrodes CA and the main pixel electrode PA. That is, in the example illustrated, in one pixel PX, two apertures are formed. Also, a first domain D1 is formed between the main common electrode CAL and the pixel electrode PE, and a second domain D2 is formed between the main common electrode CAR and the pixel electrode PE.

In the example illustrated, an initial alignment direction of liquid crystal molecules LM is a direction substantially parallel to the second direction Y, for example. However, it may be an oblique direction D which obliquely crosses the second direction Y. Here, angle θ1 formed by the initial alignment direction D relative to the second direction Y is greater than 0° and less than 45°. Note that it is extremely effective if angle θ1 to be formed is approximately 5° to approximately 25°, more preferably, approximately 10°, in terms of the alignment control of the liquid crystal molecules LM. Here, angle θ1 is formed by slightly inclining the initial alignment direction by several degrees or so relative to the second direction Y, and is 7°, for example.

Further, the pixel electrode PE may comprise a sub-pixel electrode as needed, and the common electrode CE may comprise a sub-common electrode as needed, although this will be described later.

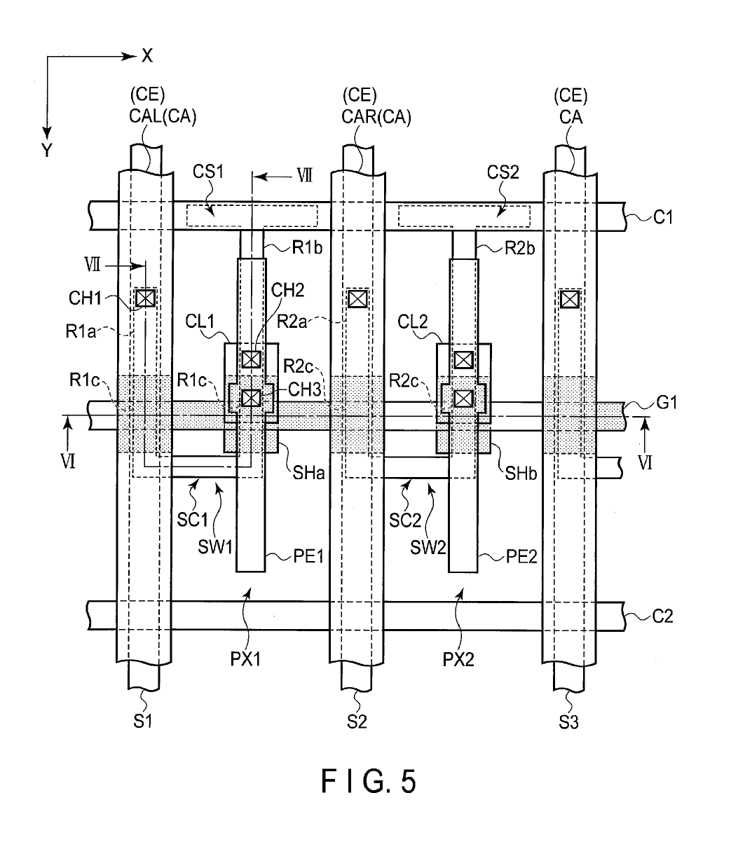

FIG. 5 is a plan view showing two adjacent pixels PX1 and PX2 of the pixels PX of the liquid crystal display panel PNL.

As shown in FIG. 5, a auxiliary capacitance line C1, a auxiliary capacitance line C2, and a scanning line G1 extend substantially linearly in the first direction X. The auxiliary capacitance line C1 is disposed on the upper end portion of each of the first pixel PX1 and the second pixel PX2. Note that the auxiliary capacitance line C1 may be disposed to extend over a boundary between pixels of the first and second pixels PX1 and PX2 and pixels above those pixels. The auxiliary capacitance line C2 is disposed on the lower end portion of each of the first pixel PX1 and the second pixel PX2. Note that the auxiliary capacitance line C2 may be disposed to extend over a boundary between pixels of the first and second pixels PX1 and PX2 and pixels below those pixels. In the second direction Y, the scanning line G1 is located between the auxiliary capacitance line C1 and the auxiliary capacitance line C2, and is opposed to a first light-shielding layer SHa and a second light-shielding layer SHb.

A first signal line S1, a second signal line S2, and a third signal line S3 extend substantially linearly in the second direction Y. The second signal line S2 is disposed between the first signal line S1 and the third signal line S3. The main common electrodes CA extend substantially linearly in the second direction Y, and are arranged to be spaced apart from each other in the first direction X. For example, the main common electrodes CA extend along the signal lines S, respectively. The main common electrode CAL is opposed to the first signal line S1, and the main common electrode CAR is opposed to the second signal line S2. A first pixel electrode PE1 and a second pixel electrode PE2 extend parallel to the main common electrodes CA. The first pixel electrode PE1 is disposed between the main common electrode CAL and the main common electrode CAR. The first pixel electrode PE1 extends from the vicinity of the upper end portion of the first pixel PX1 to the lower end portion of the same, and the second pixel electrode PE2 extends from the vicinity of the upper end portion of the second pixel PX2 to the lower end portion of the same.

A first switching element SW1 comprises a first semiconductor layer SC1, and a second switching element SW2 comprises a second semiconductor layer SC2. In the present embodiment, the first switching element SW1 and the second switching element SW2 are each formed of a double-gate thin-film transistor. In an X-Y planar view in which the main common electrode CAL is on the left side and the main common electrode CAR is on the right side, the first semiconductor layer SC1 and the second semiconductor layer SC2 are formed in the shape of letter J, roughly.

The first semiconductor layer SC1 is formed in such a way that it extends in the second direction Y along the first signal line S1, makes a turn at an area exceeding the scanning line G1, extends in the direction opposite the second direction Y along the first pixel electrode PE1, and expands to the right and left at an area opposed to the auxiliary capacitance line C1. In an area opposed to the first light-shielding layer SHa, the first semiconductor layer SC1 crosses the scanning line G1 at two places. The first semiconductor layer SC1 comprises a first region R1a, a second region R1b, and third regions R1c that exist between the first region R1a and the second region R1b. Each of the third regions R1c is an area opposed to the scanning line G1 in the first semiconductor layer SC1, and can be rephrased as a channel region. In the present embodiment, in order to form a storage capacitance CS1, the second region R1b and the auxiliary capacitance line C1 are opposed to each other.

The second semiconductor layer SC2 is formed in such a way that it extends in the second direction Y along the second signal line S2, makes a turn at an area exceeding the scanning line G1, extends in the direction opposite the second direction Y along the second pixel electrode PE2, and expands to the right and left at an area opposed to the auxiliary capacitance line C1. The second semiconductor layer SC2 crosses the scanning line G1 within an area opposed to the first light-shielding layer SHa, and further crosses the scanning line G1 within an area opposed to the second light-shielding layer SHb. The second semiconductor layer SC2 comprises a fourth region R2a, a fifth region R2b, and sixth regions R2c that exist between the fourth region R2a and the fifth region R2b. Each of the sixth regions R2c is an area opposed to the scanning line G1 in the second semiconductor layer SC2, and can be rephrased as a channel region. In the present embodiment, in order to form a storage capacitance CS2, the fifth region R2b and the auxiliary capacitance line C1 are opposed to each other.

A conductive layer CL1 is opposed to both of the first semiconductor layer SC1 and the first pixel electrode PE1. A conductive layer CL2 is opposed to both of the second semiconductor layer SC2 and the second pixel electrode PE2.

The first light-shielding layer SHa and the second light-shielding layer SHb are formed of metal, and are disposed while maintaining an insulation distance from each other. In the present embodiment, the first light-shielding layer SHa serves as a conductive layer. The first light-shielding layer SHa is formed within an area substantially opposed to the main common electrodes CAL and CAR, the first pixel electrode PE1, the conductive layer CL1, and the scanning line G1. The second light-shielding layer SHb is formed within an area substantially opposed to the second pixel electrode PE2 and the conductive layer CL2.

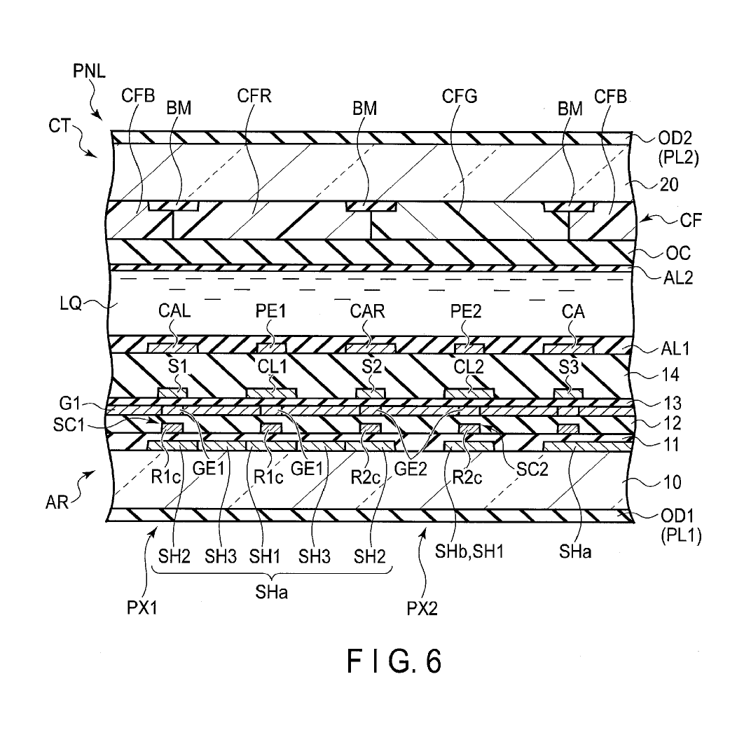

FIG. 6 is a cross-sectional view showing a part of the liquid crystal display panel PNL taken along line VI-VI of FIG. 5.

As shown in FIG. 6, the array substrate AR is formed by using a first insulating substrate 10 having light transmissivity, such as a glass substrate or a plastic substrate. The first light-shielding layer SHa and the second light-shielding layer SHb are provided on the first insulating substrate 10.

A first segment SH1 opposed to the first pixel electrode PE1 and the conductive layer CL1, a second segment SH2 opposed to the main common electrode CAL and the first signal line S1, another second segment SH2 opposed to the main common electrode CAR and the second signal line S2, and third segments SH3 each of which connects the first segment SH1 and either one of the second segments SH2 integrally form the first light-shielding layer SHa. As the third segments SH3 are disposed immediately below the scanning line G1, it is possible to suppress or prevent reduction of light transmissivity. The second light-shielding layer SHb is formed of a first segment SH1 which is opposed to the second pixel electrode PE2 and the conductive layer CL2. The first segment SH1 has substantially the same width as the conductive layer CL1 or the conductive layer CL2. The second segment SH2 has substantially the same width as the main common electrode CAL or the main common electrode CAR.

A first insulating film 11 is formed on the first insulating substrate 10, the first light-shielding layer SHa, and the second light-shielding layer SHb. The first semiconductor layer SC1 including the third regions R1c, and the second semiconductor layer SC2 including the sixth regions R2c are provided on the first insulating film 11. Each of the third regions R1c and the sixth regions R2c is opposed to either of the first segment SH1 and the second segment SH2. A second insulating film 12 is formed on the first insulating film 11, the first semiconductor layer SC1, and the second semiconductor layer SC2. The second insulating film 12 may be referred to as a gate insulating film.

A first scanning line C1 is formed on the second insulating film 12. The first scanning line G1 comprises a first gate electrode GE1 and a second gate electrode GE2. In the present embodiment, two parts in the first scanning line G1 serve as the first gate electrodes GE1, respectively, and the other two parts serve as the second gate electrodes GE2, respectively. The first gate electrodes GE1 are located above the third regions R1c, and arranged to be opposed to the third regions R1c, respectively. The second gate electrodes GE2 are located above the sixth regions R2c, and arranged to be opposed to the sixth regions R2c, respectively. A third insulating film 13 is formed on the second insulating film 12 and the first scanning line G1.

The first to third signal lines S1 to S3, and the conductive layers CL1 and CL2 are provided on the third insulating film 13. For example, each of the first signal line S1 and the conductive layer CL1 is located right above either one of the third regions R1c, and each of the second signal line S2 and the conductive layer CL2 is located right above either one of the sixth regions R2c. A fourth insulating film 14 is formed on the third insulating film 13, the first to third signal lines S1 to S3, and the conductive layers CL1 and CL2. The first insulating film 11, the second insulating film 12, and the third insulating film 13 are formed of an inorganic material such as silicon nitride (SiN) or silicon oxide (SiO). The fourth insulating film 14 is formed of an organic material such as an acrylic resin.

The first pixel electrode PE1, the second pixel electrode PE2, and the main common electrodes CA (CAL, CAR) are formed on the fourth insulating film 14. The main common electrode CAL is located right above the first signal line S1, the first pixel electrode PE1 is located right above the conductive layer CL1, the main common electrode CAR is located right above the second signal line S2, and the second pixel electrode PE2 is located right above the conductive layer CL2. A first alignment film AL1 is disposed on a surface of the array substrate AR, which is opposed to the counter-substrate CT. The first alignment film AL1 covers the first pixel electrode PE1, the second pixel electrode PE2, and the main common electrodes CA, and is also disposed on the fourth insulating film 14. The first alignment film AL1 is in contact with the liquid crystal layer LQ. The first alignment film AL1 is formed of a material which exhibits horizontal alignment properties.

Meanwhile, the counter-substrate CT is formed by using a second insulating substrate 20 having light transmissivity, such as a glass substrate or a plastic substrate. The counter-substrate CT includes a color filter CF, an overcoat layer OC, a second alignment film AL2, etc. The color filter CF includes a black matrix BM and color layers CFR, CFG, and CFB. The black matrix BM is formed on an inner surface of the second insulating substrate 20. The black matrix BM is formed such that it delimits each of the pixels PX. In the present embodiment, the black matrix BM is formed in a lattice shape so that it is opposed to conductive lines such as the signal lines S and the auxiliary capacitance lines C.

The color layers CFR, CFG, and CFB are formed on an inner surface of the second insulating substrate 20. The color layers CFR, CFG, and CFB are aligned in order in the first direction X, and all of them extend in the second direction Y and are formed in a stripe shape. An end portion of each of the color layers CFR, CFG, and CFB overlaps the black matrix BM. The color layer CFR is a red layer, is opposed to the first pixel electrode PE1, and forms the first pixel PX1 which is red. The color layer CFG is a green layer, is opposed to the second pixel electrode PE2, and forms the second pixel PX2 which is green. The color layer CFB is a blue layer, and similarly forms a blue pixel.

Note that in the present embodiment, a unit pixel, which is the minimum unit constituting a color image, is formed of three color pixels, i.e., the red, green, and blue pixels. However, the unit pixel is not limited to a combination of the three color pixels described above. For example, the unit pixel may be composed of four color pixels including a white pixel in addition to the red, green, and blue pixels. In this case, a transparent or slightly colored filter may be arranged on the white pixel, or the filter of the white pixel may be omitted.

The overcoat layer OC covers the color filter CF. The overcoat layer OC is formed of a transparent resin material. The second alignment film AL2 is disposed on a surface of the counter-substrate CT, which is opposed to the array substrate AR. The second alignment film AL2 is in contact with the liquid crystal layer LQ. The second alignment film AL2 is formed of a material having a horizontal alignment property.

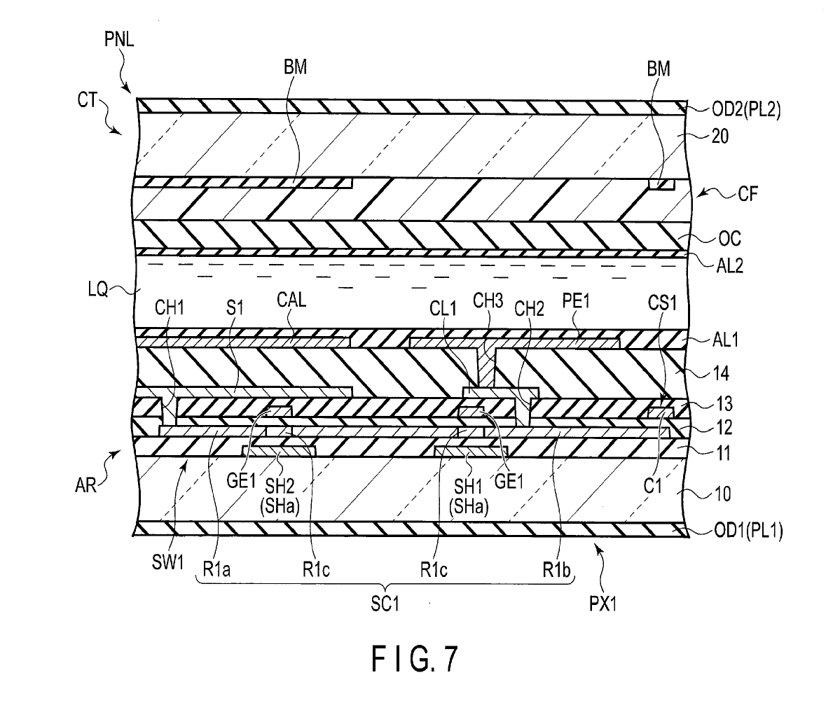

FIG. 7 is a cross-sectional view showing a part of the liquid crystal display panel PNL taken along line VII-VII of FIG. 5.

As shown in FIG. 7, the second region R1b, the auxiliary capacitance line C1, and the second insulating film 12 interposed between the second region R1b and the auxiliary capacitance line C1 form the storage capacitance CS1. The first signal line S1 is in contact with the first region R1a through a contact hole CH1 formed in the second insulating film 12 and the third insulating film 13. The potential of the first region R1a is set to be the same as the potential of the first signal line S1. The conductive layer CL1 is in contact with the with the second region R1b through a contact hole CH2 formed in the second insulating film 12 and the third insulating film 13. The first pixel electrode PE1 is in contact with the conductive layer CL1 through a contact hole CH3 formed in the fourth insulating film 14. The potential of the second region R1b is set to be the same as the potential of the first pixel electrode PE1. The same applies to the second semiconductor layer SC2, and the potential of the fourth region R2a is set to be the same as the potential of the second signal line S2. The potential of the fifth region R2b is set to be the same as the potential of the second pixel electrode PE2.

Since the first signal line S1 forms a first electrostatic capacitive coupling with the first light-shielding layer SHa, the first region R1a is opposed to the first light-shielding layer SHa at a distance. The same applies to the second signal line S2 described above, and since the second signal line S2 forms a second electrostatic capacitive coupling with the first light-shielding layer SHa, the fourth region R2a is opposed to the first light-shielding layer SHa at a distance. Since the first pixel electrode PE1 forms a third electrostatic capacitive coupling with the first light-shielding layer SHa, the second region R1b is opposed to the first light-shielding layer SHa at a distance.

The first alignment film AL1 and the second alignment film AL2 are subjected to an alignment treatment (for example, a rubbing treatment and an optical alignment treatment) for initially aligning the liquid crystal molecules. The array substrate AR and the counter-substrate CT are arranged such that the first alignment film AL1 and the second alignment film AL2 of these substrates are opposed to each other. The array substrate AR and the counter-substrate CT are disposed with a predetermined gap by spacers. The array substrate AR and the counter-substrate CT are adhered to each other by a sealing member, which is not shown, in a state in which the gap is formed therebetween. The liquid crystal layer LQ is formed in a space surrounded by the array substrate AR, the counter-substrate CT and the sealing member.

A first optical element OD1 is adhered to the external surface of the array substrate AR, that is, the external surface of the first insulating substrate 10 which constitutes the array substrate AR by an adhesive, or the like. Further, a second optical element OD2 is adhered to the external surface of the counter-substrate CT, that is, the external surface of the second insulating substrate 20 which constitutes the counter-substrate CT by an adhesive, or the like.

As shown in FIGS. 4, 6, and 7, the first optical element OD1 includes a first polarizer PL1 having a first polarization axis AX1. The second optical element OD2 includes a second polarizer PL2 having a second polarization axis AX2. The first polarization axis AX1 and the second polarization axis AX2 have an orthogonal positional relationship, for example. One of the polarizers are disposed such that the polarization axis of the polarizer is parallel to a direction of a long axis of the liquid crystal molecules LM, that is, a first alignment treatment direction PD1 or a second alignment treatment direction PD2 (or parallel to the second direction Y), or orthogonal to the aforementioned long-axis direction (or parallel to the first direction X). Thereby, a normally black mode is achieved.

In an example shown in (a) of FIG. 4, the first polarizer PL1 is disposed such that the first polarization axis AX1 thereof is orthogonal to the initial alignment direction (the second direction Y) of the liquid crystal molecules LM (that is, parallel to the first direction X), and the second polarizer PL2 is disposed such that the second polarization axis AX2 thereof is parallel to the initial alignment direction of the liquid crystal molecules LM (that is, parallel to the second direction Y).

Further, in an example shown in (b) of FIG. 4, the second polarizer PL2 is disposed such that the second polarization axis AX2 thereof is orthogonal to the initial alignment direction (the second direction Y) of the liquid crystal molecules LM (that is, parallel to the first direction X), and the first polarizer PL1 is disposed such that the first polarization axis AX1 thereof is parallel to the initial alignment direction of the liquid crystal molecules LM (that is, parallel to the second direction Y).

In a state in which no voltage is applied to the liquid crystal layer LQ, that is, at a no-electric-field time (off-time) in which no potential difference (or an electric field) is produced between the pixel electrode PE and the common electrode CE, the liquid crystal molecules LM are aligned such that the long axis of each of the liquid crystal molecules LM is oriented to the first alignment treatment direction PD1 of the first alignment film AL1 or the second alignment treatment direction PD2 of the second alignment film AL2, as indicated by a dashed line. Such an off-time corresponds to the initial alignment state, and the alignment direction of the liquid crystal molecules LM at the off-time corresponds to the initial alignment direction.

When the first alignment treatment direction PD1 and the second alignment treatment direction PD2 are parallel to each other and their directions are opposite, in a cross-section of the liquid crystal layer LQ, the liquid crystal molecules LM are aligned with a substantially even pretilt angle near the first alignment film AL1, near the second alignment film AL2, and an intermediate portion of the liquid crystal layer LQ (homogeneous alignment). Also, when the first alignment treatment direction PD1 and the second alignment treatment direction PD2 are parallel to each other and their directions are the same, in the cross-section of the liquid crystal layer LQ, the liquid crystal molecules LM are aligned to be substantially parallel (i.e., the pretilt angle is substantially zero) in the intermediate portion of the liquid crystal layer LQ, and aligned such that the pretilt angle near the first alignment film AL1 and the pretilt angle near the second alignment film AL2 become symmetrical with respect to the intermediate portion as the border (splay alignment).

As shown in FIGS. 1, 4, and 6, part of light from the backlight unit BL passes through the first polarizer PL1, and enters the liquid crystal display panel PNL. The polarized state of light which has entered the liquid crystal display panel PNL varies depending on the alignment state of the liquid crystal molecules LM when the light passes through the liquid crystal layer LQ. In the off-state, the light passing through the liquid crystal layer LQ is absorbed by the second polarizer PL2 (black display).

Meanwhile, in a state in which a potential difference is produced between the pixel electrode PE and the common electrode CE (on-state), a lateral electric field which is substantially parallel to the substrate (or an oblique electric field) is produced between the pixel electrode PE and the common electrode CE. Accordingly, as indicated by a solid line in FIG. 4, the liquid crystal molecules LM are rotated within a plane substantially parallel to the substrate main surface such that the long axes of the liquid crystal molecules LM are substantially parallel to the direction of the electric field.

In the example shown in FIG. 4, the liquid crystal molecule LM in a first domain D1 rotates clockwise relative to the second direction Y, and is aligned to be oriented to the lower left in this figure along the electric field. The liquid crystal molecule LM in a second domain D2 rotates anticlockwise relative to the second direction Y, and is aligned to be oriented to the lower right in this figure along the electric field.

As can be seen, in each of the pixels PX, in a state in which the lateral electric field (or the oblique electric field) is produced between the pixel electrode PE and the common electrode CE, the alignment directions of the liquid crystal molecules LM are separated into at least two directions, and domains are formed in each of the alignment directions. That is, in one pixel PX, at least two domains are formed.

At the on-state as described above, part of light incident on the liquid crystal display panel PNL from the backlight unit BL passes through the first polarizer PL1 and enters the liquid crystal display panel PNL. The polarized state of light which has entered the liquid crystal layer LQ is changed when the light passes through each of the two domains (apertures) of the first domain D1 and the second domain D2. Thus, at the on-state, at least part of the light which has passed through the liquid crystal layer LQ is transmitted through the second polarizer PL2 (white display).

Note that in the on-state, a lateral electric field is barely produced in the vicinity of the pixel electrode PE or in the vicinity of the common electrode CE (or that a sufficient amount of electric field for driving the liquid crystal molecules LM is not formed). Accordingly, the liquid crystal molecules LM barely move from the initial alignment direction as in the off-state. Consequently, as described above, even if the pixel electrode PE and the common electrode CE are formed by a conductive material having light transmissivity, light is barely transmitted in these areas and these areas barely contribute to the display in the on-state. For this reason, the pixel electrode PE and the common electrode CE are not necessarily formed of a transparent conductive material, and may be formed by using a conductive material having a light-shielding property such as aluminum and silver.

Next, the relationship between light transmissivity and vertical crosstalk will be described.

In the liquid crystal display panel PNL according to the present embodiment, an electric field from the signal lines S may leak to the liquid crystal layer LQ, and when the electric field leaks, vertical crosstalk may occur, which affects the display quality. Here, the vertical crosstalk refers to a phenomenon in which a brightness level is changed as the liquid crystal molecules maintained in the liquid crystal layer LQ is disturbed from the original alignment when, for example, a pixel potential for displaying white is supplied to the signal line S connected to the pixel PX while the pixel PX is set at a pixel potential for displaying black. In particular, in a display mode of controlling the alignment of the liquid crystal molecules by forming the pixel electrode PE and the main common electrode CA (common electrode CE) in a layer of the same level, as in the present embodiment, an influence of a leakage electric field from the signal lines S is significant.

As the measures against the leakage electric field, one option is to increase the width of the main common electrode CA which also serves as a shield against the leakage electric field from the signal lines S. However, when the width of the main common electrode CA is increased, an area which does not contribute to display is increased, which leads to reduction of light transmissivity or having difficulty in achieving higher definition.

Hence, the inventor has found a technique of suppressing vertical crosstalk caused by the leakage electric field from the signal lines S without increasing the width of the main common electrode CA. More specifically, the inventor has found that the direction of change in a brightness level caused by the leakage electric field from the signal lines S is opposite to the direction of change in a brightness level by a coupling capacitance between the signal line S and the pixel electrode PE. That is, by forming the coupling capacitance and canceling the change in the brightness level caused by the leakage electric field, suppressing vertical crosstalk is enabled.

Next, the coupling capacitance will be described. FIG. 8 is an illustration for describing the state in which a first coupling capacitance Cp1 is formed between the first signal line S1 and the first pixel electrode PE1 shown in FIG. 5 by using the first light-shielding layer SHa, and a second coupling capacitance Cp2 is formed between the second signal line S2 and the first pixel electrode PE1 by using the first light-shielding layer SHa.

As shown in FIG. 8, the first coupling capacitance Cp1 includes a capacitance formed between the first region R1a and the first light-shielding layer SHa, and a capacitance formed between the second region R1b and the first light-shielding layer SHa. In other words, the first coupling capacitance Cp1 is formed of the above-described first electrostatic capacitive coupling and the third electrostatic capacitive coupling. The second coupling capacitance Cp2 includes a capacitance formed between the fourth region R2a and the first light-shielding layer SHa, and a capacitance formed between the second region R1b and the first light-shielding layer SHa. In other words, the second coupling capacitance Cp2 is formed of the above-described second electrostatic capacitive coupling and the third electrostatic capacitive coupling. In the present embodiment, various members for forming the first coupling capacitance Cp1, and various members for forming the second coupling capacitance Cp2 are arranged symmetrically, and the value of the first coupling capacitance Cp1 and the value of the second coupling capacitance Cp2 are made the same (Cp1=Cp2). Further, the value of the first coupling capacitance Cp1 and the value of the second coupling capacitance Cp2 can be adjusted by changing the length of the second segment SH2 in the second direction Y, for example.

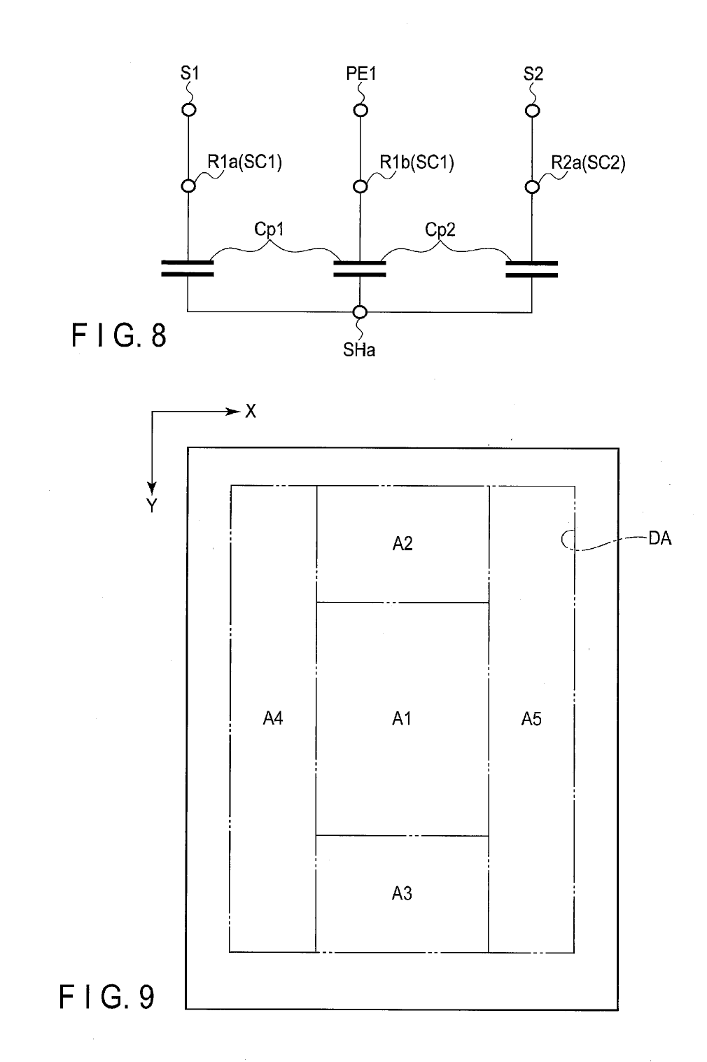

Next, an example of suppressing vertical crosstalk by forming the first coupling capacitance Cp1 and the second coupling capacitance Cp2 will be described. FIG. 9 is an illustration for describing the state in which the display area DA of the liquid crystal display panel PNL is segmented into a first display area A1 to a fifth display area A5.

As shown in FIG. 9, in an X-Y planar view, a central area of the display area DA is set as the first display area A1. A second display area A2 is an area on the upper side of the first display area A1, and is set as an area which is to be scanned before the first display area A1 in one frame period. A third display area A3 is an area on the lower side of the first display area A1, and is set as an area which is to be scanned after the first display area A1 in one frame period. A fourth display area A4 is an area on the left side of the first display area A1, the second display area A2, and the third display area A3. The fifth display area A5 is an area on the right side of the first display area A1, the second display area A2, and the third display area A3.

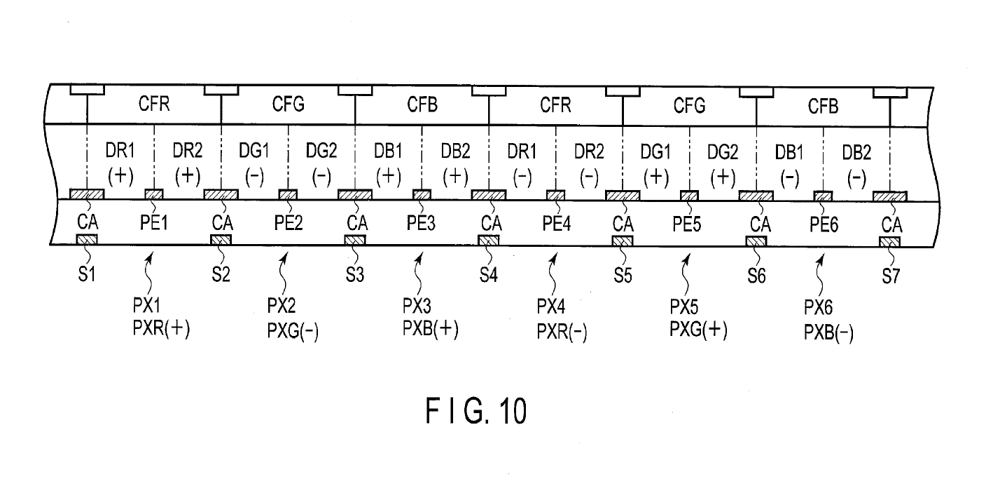

FIG. 10 is a cross-sectional view showing a part of the liquid crystal display panel PNL, and shows first to seventh signals lines S1 to S7, first to sixth pixel electrodes PE1 to PE6, the common electrode CE, color layers CFR, CFG, and CFG of different colors, and domains D of the pixels PX of different colors which have either positive or negative polarity. Here, it is assumed that the first to sixth pixels PX1 to PX6 shown in FIG. 10 are provided in the second display area A2.

As shown in FIG. 10, a drive method of the liquid crystal display device DSP according to the present embodiment is what is called a column-inversion drive scheme. Accordingly, the polarity of image signals given to the pixel electrodes PE of the pixels PX in odd-numbered columns, respectively, is different from the polarity of image signals given to the pixel electrodes PE of the pixels PX in even-numbered columns, respectively, in one frame period. Further, the polarity of image signals given to the respective pixel electrodes PE is reversed in each frame period. The example shown in FIG. 10 specifies the polarity of each of the first to sixth pixels PX1 to PX6 in an arbitrary frame period. The first pixel PX1, the third pixel PX3, and the fifth pixel PX5 have positive polarity, and the second pixel PX2, the fourth pixel PX4, and the sixth pixel PX6 have negative polarity. The sign (+) is indicated in the domains D of the positive pixels PX, and the sign (−) is indicated in the domains D of the negative pixels PX.

The first pixel PX1 is a red pixel PXR, includes the first pixel electrode PE1 electrically connected to the first signal line S1, and the color layer CFR, and forms a first domain DR1 and a second domain DR2. The second pixel PX2 is a green pixel PXG, includes the second pixel electrode PE2 electrically connected to the second signal line S2, and the color layer CFG, and forms a first domain DG1 and a second domain DG2. The third pixel PX3 is a blue pixel PXB, includes the third pixel electrode PE3 electrically connected to the third signal line S3, and the color layer CFB, and forms a first domain DB1 and a second domain DB2.

The fourth pixel PX4 is a red pixel PXR, includes the fourth pixel electrode PE4 electrically connected to the fourth signal line S4, and the color layer CFR, and forms a first domain DR1 and a second domain DR2. The fifth pixel PX5 is a green pixel PXG, includes the fifth pixel electrode PE5 electrically connected to the fifth signal line S5, and the color layer CFG, and forms a first domain DG1 and a second domain DG2. The sixth pixel PX6 is a blue pixel PXB, includes the sixth pixel electrode PE6 electrically connected to the sixth signal line S6, and the color layer CFB, and forms a first domain DB1 and a second domain DB2.

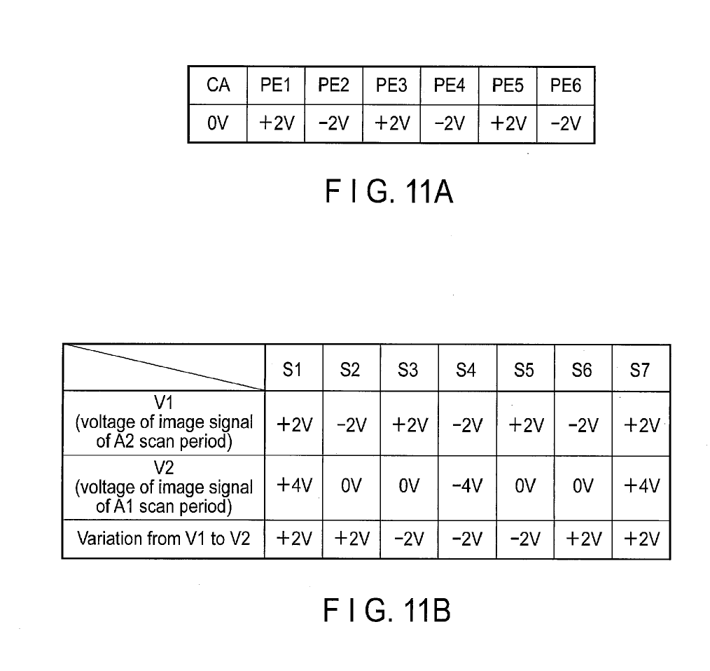

FIG. 11A is a table showing the values of voltages applied to the main common electrode CA (common electrode CE) and the first to sixth pixel electrodes PE1 to PE6 in the second display area A2 in an arbitrary frame period when red display is performed in the first display area A1, and halftone display is performed in the second to fifth display areas A2 to A5. FIG. 11B is a table showing voltage V1 of an image signal which drives each of the first to seventh signal lines S1 to S7 in a scan period of the second display area A2, voltage V2 of the image signal which drives each of the first to seventh signal lines S1 to S7 in a scan period of the first display area A1, and variations in the voltage values of each of the first to seventh signal lines S1 to S7.

As shown in FIGS. 11A and 11B, the main common electrode CA (common electrode CE) is set at a constant potential, and in the example depicted, the main common electrode CA (common electrode CE) is set at ground potential (0 V) by a common driving signal.

The image signal which drives each of the first signal line S1, the third signal line S3, the fifth signal line S5, and the seventh signal line S7 in the scan period of the second display area A2 is one which has positive polarity and of a halftone level, and voltage V1 of this image signal is +2 V. The positive, halftone-level image signal is given to the first pixel electrode PE1, the third pixel electrode PE3, and the fifth pixel electrode PE5 in the second display area A2, and a voltage of +2 V is applied. Meanwhile, the image signal which drives each of the second signal line S2, the fourth signal line S4, and the sixth signal line S6 is one which has negative polarity and of a halftone level, and voltage V1 of this image signal is −2 V. The negative, halftone-level image signal is given to the second pixel electrode PE2, the fourth pixel electrode PE4, and the sixth pixel electrode PE6 in the second display area A2, and a voltage of −2 V is applied.

The image signal which drives the first signal line S1 in the scan period of the first display area A1 following the scan period of the second display area A2 is one which has positive polarity and of a high gradation level (white level), and voltage V1 of this image signal is +4 V. The image signal which drives the fourth signal line S4 is one which has negative polarity and of a high gradation level (white level), and voltage V1 of this image signal is −4 V. The image signal which drives each of the second signal line S2, the third signal line S3, the fifth signal line S5, and the sixth signal line S6 is one of a low gradation level (black level), and voltage V1 of this image signal is zero, which is the same as the voltage value of the main common electrode CA.

The variation in the voltage values of each of the first signal line S1, the second signal line S2, the sixth signal line S6, and the seventh signal line S7 is +2 V, and the variation in the voltage values of each of the third to fifth signal lines S3 to S5 is −2 V.

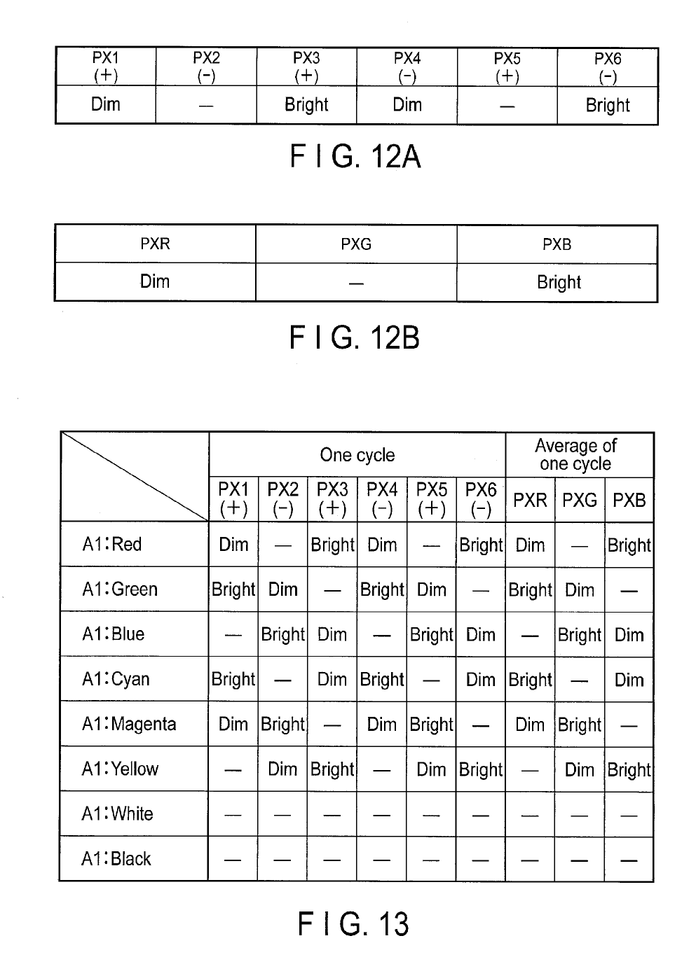

Each of FIGS. 12A and 12B is a table showing a change in the brightness caused by the leakage electric field from the first to seventh signal lines S1 to S7 in an arbitrary frame period when red display is performed in the first display area A1, and halftone display is performed in the second to fifth display areas A2 to A5. FIG. 12A shows a change in the average brightness of the pixels PX of different colors having either positive or negative polarity of the second display area A2 as compared to the brightness of the halftone display. FIG. 12B shows a change in the average brightness of the pixels PX of different colors of the second display area A2 as compared to the brightness of the halftone display.

As shown in FIGS. 12A and 12B, it can be understood that the brightness of each domain D is changed by the influence of the leakage electric field from the first to seventh signal lines S1 to S7. That is, when the variation from V1 to V2 is +2 V, the light transmissivity is reduced in the positive domains D and those domains are dimmed as compared to the brightness of the halftone level, whereas, the light transmissivity is increased in the negative domains D and those domains are brightened as compared to the brightness of the halftone level. Meanwhile, when the variation from V1 to V2 is −2 V, the light transmissivity is increased in the positive domains D and those pixels are brightened as compared to the brightness of the halftone level, whereas, the light transmissivity is reduced in the negative domains D and those domains are dimmed as compared to the brightness of the halftone level. The reason why the domains are brightened as compared to the brightness of the halftone level is because a change in the potential of the signal lines S works in the direction of urging the movement of the liquid crystal molecules, and the reason why the domains are dimmed as compared to the brightness of the halftone level is because a change in the potential of the signal lines S works in the direction of inhibiting the movement of the liquid crystal molecules.

Hence, in the first pixel PX1 having the positive polarity, a change in the brightness of each of the domains DR1 (+) and DR2 (+) is superimposed, and the pixel is dimmed as compared to the halftone level. In the second pixel PX2 having the negative polarity, a change in the brightness of each of the domains DG1 (−) and DG2 (−) is balanced out (i.e., compensated), and the brightness of the halftone level can be maintained. In the third pixel PX3 having the positive polarity, a change in the brightness of each of the domains DB1 (+) and DB2 (+) is superimposed, and the pixel is brightened as compared to the halftone level. In the fourth pixel PX4 having the negative polarity, a change in the brightness of each of the domains DR1 (−) and DR2 (−) is superimposed, and the pixel is dimmed as compared to the halftone level. In the fifth pixel PX5 having the positive polarity, a change in the brightness of each of the domains DG1 (+) and DG2 (+) is balanced out, and the brightness of the halftone level can be maintained. In the sixth pixel PX6 having the negative polarity, a change in the brightness of each of the domains DB1 (−) and DB2 (−) is superimposed, and the pixel is brightened as compared to the halftone level.

Therefore, taking the change in the brightness for each color, the red pixel PXR including the first pixel PX1 and the fourth pixel PX4 is dimmed on the average as compared to the halftone level. The green pixel PXG including the second pixel PX2 and the fifth pixel PX5 maintains the brightness of the halftone level on the average. The blue pixel PXB including the third pixel PX3 and the sixth pixel PX6 is brightened on the average as compared to the halftone level. The above result applies when an average of one cycle is taken.

From the matters described above, when a leakage electric field from the signal lines S is produced, this inhibits performing halftone display or achromatic color display in the second display area A2. When red display is performed in the first display area A1, in the second display area A2, blue is emphasized and red is de-emphasized as compared to the halftone level. As a result of the fact that red is de-emphasized, the second display area A2 may be displayed in pale blue. In the above period, the third display area A3 is colored reversed from the second display area A2. That is, in the third display area A3, red is emphasized and blue is de-emphasized as compared to the halftone level. As a result of the fact that blue is de-emphasized, the third display area A3 may be displayed in pale red.

In the above, a change in the brightness, which is caused by the leakage electric field from the first to seventh signal lines S1 to S7 in an arbitrary frame period when red display is performed in the first display area A1, and halftone display is performed in the second to fifth display areas A2 to A5, has been described. However, the above similarly applies to a case where display of a color other than red is to be performed in the first display area A1.

FIG. 13 is a table showing a change in the brightness caused by the leakage electric field from the first to seventh signal lines S1 to S7 when red display, green display, blue display, cyan display, magenta display, yellow display, white display, or black display is performed in the first display area A1, and halftone display is performed in the second to fifth display areas A2 to A5. More specifically, FIG. 13 shows a brightness of each of the pixels PX which are either positive or negative of the second display area A2 as compared to when the halftone display is performed in an arbitrary cycle, and the average brightness of the pixels PX of different colors of the second display area A2 as compared to when the halftone display is performed in the average of one cycle. Here, “cycle” described above is not intended as a temporal cycle (period), but that six pixels PX which are distinguished from each other in their colors and polarities arranged in the first direction X constitute one cycle.

As shown in FIG. 13, while a case where the red display is performed in the first display area A1 is as shown in FIGS. 12A and 12B, also in cases where the green display, blue display, cyan display, magenta display, and yellow display are performed in the first display area A1, it can be understood that occurrence of a leakage electric field from the signal lines S inhibits performing halftone display or achromatic color display in the second display area A2. Further, vertical crosstalk caused by an electric field leakage from the signal lines S occurs.

Here, when green display is performed in the first display area A1, an image signal which drives the second signal line S2 in the scan period of this first display area A1 is one which has negative polarity and of a high gradation level (white level), and voltage V1 of this image signal is −4 V. An image signal which drives the fifth signal line S5 is one which has positive polarity and of a high gradation level (white level), and voltage V1 of this image signal is +4 V. An image signal which drives each of the first signal line S1, the third signal line S3, the fourth signal line S4, and the sixth signal line S6 is one of a low gradation level (black level), and voltage V1 of this image signal is zero, which is the same as the voltage value of the main common electrode CA.

When blue display is performed in the first display area A1, an image signal which drives the third signal line S3 in the scan period of this first display area A1 is one which has positive polarity and of a high gradation level (white level), and voltage V1 of this image signal is +4 V. The image signal which drives the sixth signal line S6 is one which has negative polarity and of a high gradation level (white level), and voltage V1 of this image signal is −4 V. An image signal which drives each of the first signal line S1, the second signal line S2, the fourth signal line S4, and the fifth signal line S5 is one of a low gradation level (black level), and voltage V1 of this image signal is zero, which is the same as the voltage value of the main common electrode CA.

When cyan display is performed in the first display area A1, in the present embodiment, the cyan display is achieved by synthesizing green display and blue display. In the scan period of this first display area A1, image signals which drive the second signal line S2 and the sixth signal line S6 are ones which have negative polarity and of a high gradation level (white level), and voltage V1 of these image signals is −4 V. Image signals which drive the third signal line S3 and the fifth signal line S5 are ones which have positive polarity and of a high gradation level (white level), and voltage V1 of these image signals is +4 V. Image signals which drive the first signal line S1 and the fourth signal line S4 are ones of a low gradation level (black level), and voltage V1 of these image signals is zero, which is the same as the voltage value of the main common electrode CA.

When magenta display is performed in the first display area A1, in the present embodiment, the magenta display is achieved by synthesizing red display and blue display. In the scan period of this first display area A1, image signals which drive the first signal line S1 and the third signal line S3 are ones which have positive polarity and of a high gradation level (white level), and voltage V1 of these image signals is +4 V. Image signals which drive the fourth signal line S4 and the sixth signal line S6 are ones which have negative polarity and of a high gradation level (white level), and voltage V1 of these image signals is −4 V. Image signals which drive the second signal line S2 and the fifth signal line S5 are ones of a low gradation level (black level), and voltage V1 of these image signals is zero, which is the same as the voltage value of the main common electrode CA.

When yellow display is performed in the first display area A1, in the present embodiment, the yellow display is achieved by synthesizing red display and green display. In the scan period of this first display area A1, image signals which drive the first signal line S1 and the fifth signal line S5 are ones which have positive polarity and of a high gradation level (white level), and voltage V1 of these image signals is +4 V. Image signals which drive the second signal line S2 and the fourth signal line S4 are ones which have negative polarity and of a high gradation level (white level), and voltage V1 of these image signals is −4 V. Image signals which drive the third signal line S3 and the sixth signal line S6 are ones of a low gradation level (black level), and voltage V1 of these image signals is zero, which is the same as the voltage value of the main common electrode CA.

Note that when white color display or black color display is performed in the first display area A1, since a change in the brightness is balanced out per pixel PX of the second display area A2, the halftone display can be maintained. Similarly, the halftone display can be maintained in the third display area A3.

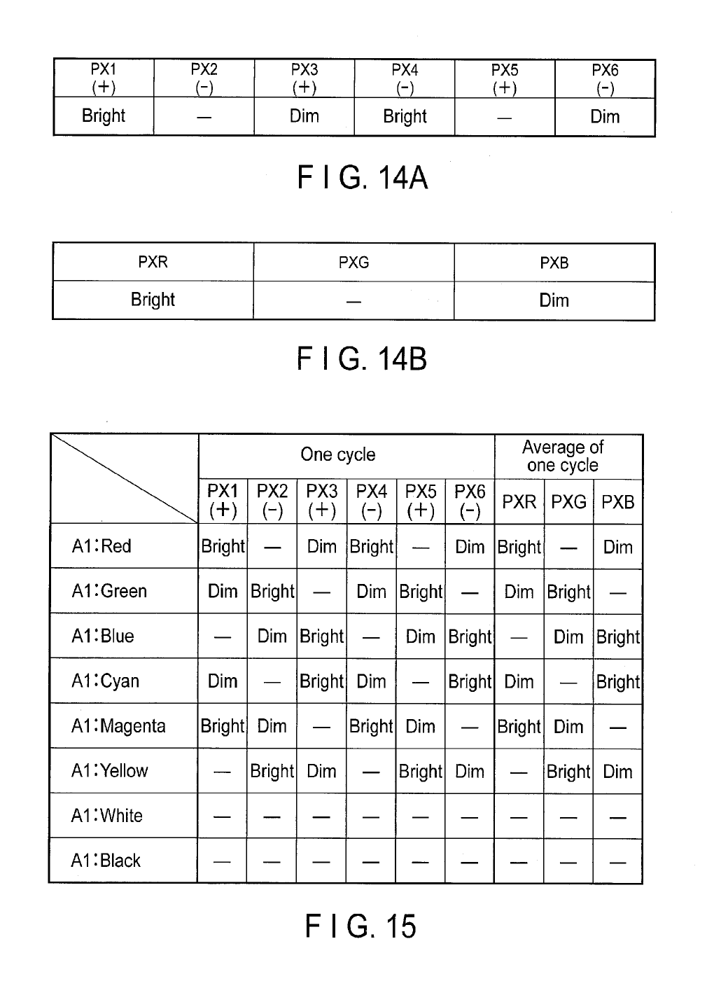

Each of FIGS. 14A and 14B is a table showing a change in the brightness caused by a coupling capacitance formed between the signal line S and the pixel electrode PE in an arbitrary frame period when red display is performed in the first display area A1, and halftone display is performed in the second to fifth display areas A2 to A5. FIG. 14A shows a change in the average brightness of the pixels PX of different colors having either positive or negative polarity of the second display area A2 as compared to the brightness of the halftone display. FIG. 14B shows a change in the average brightness of the pixels PX of different colors of the second display area A2 as compared to the brightness of the halftone display.

Note that in the descriptions of FIGS. 14A, 14B, and 15, it is assumed that the first coupling capacitance Cp1 and the second coupling capacitance Cp2 are formed in each of the first to sixth pixels PX1 to PX6. In the present embodiment, Cp1 is equal to Cp2.

As shown in FIGS. 14A and 14B, by forming each of the first coupling capacitance Cp1 and the second coupling capacitance Cp2 between the signal line S and the pixel electrode PE, the brightness in each of the pixels PX is changed. That is, when the variation from V1 to V2 is +2 V, because of the first coupling capacitance Cp1 or the second coupling capacitance Cp2, the potential of the pixel electrode PE can be raised. When the variation from V1 to V2 is −2 V, because of the first coupling capacitance Cp1 or the second coupling capacitance Cp2, the potential of the pixel electrode PE can be lowered.

When the potential of the pixel electrode PE is raised, the light transmissivity can be increased in the positive pixels PX and those pixels PX are brightened as compared to the halftone level, whereas, the light transmissivity can be reduced in the negative pixels PX and those pixels are dimmed as compared to the halftone level. Meanwhile, when the potential of the pixel electrode PE is lowered, the light transmissivity can be reduced in the positive pixels PX and those pixels PX are dimmed as compared to the halftone level, whereas, the light transmissivity can be increased in the negative pixels PX and those pixels are brightened as compared to the halftone level. The reason why the pixels are brightened as compared to the brightness of the halftone level is because a potential difference between the pixel electrode PE and the main common electrode CA is increased and works in the direction of urging the movement of the liquid crystal molecules, and the reason why the pixels are dimmed as compared to the brightness of the halftone level is because the above potential difference is reduced and works in the direction of inhibiting the movement of the liquid crystal molecules.

Hence, in the first pixel PX1 having the positive polarity, a change in the brightness caused by the first coupling capacitance Cp1 and the second coupling capacitance Cp2 is superimposed, and the pixel is brightened as compared to the halftone level. In the second pixel PX2 having the negative polarity, a change in the brightness caused by the first coupling capacitance Cp1 and the second coupling capacitance Cp2 is balanced out, and the brightness of the halftone level can be maintained. In the third pixel PX3 having the positive polarity, a change in the brightness caused by the first coupling capacitance Cp1 and the second coupling capacitance Cp2 is superimposed, and the pixel is dimmed as compared to the halftone level. In the fourth pixel PX4 having the negative polarity, a change in the brightness caused by the first coupling capacitance Cp1 and the second coupling capacitance Cp2 is superimposed, and the pixel is brightened as compared to the halftone level. In the fifth pixel PX5 having the positive polarity, a change in the brightness caused by the first coupling capacitance Cp1 and the second coupling capacitance Cp2 is balanced out, and the brightness of the halftone level can be maintained. In the sixth pixel PX6 having the negative polarity, a change in the brightness caused by the first coupling capacitance Cp1 and the second coupling capacitance Cp2 is superimposed, and the pixel is dimmed as compared to the halftone level.

Accordingly, taking the change in the brightness for each color, the red pixel PXR including the first pixel PX1 and the fourth pixel PX4 is brightened on the average as compared to the halftone level. The green pixel PXG including the second pixel PX2 and the fifth pixel PX5 maintains the brightness of the halftone level on the average. The blue pixel PXB including the third pixel PX3 and the sixth pixel PX6 is dimmed on the average as compared to the halftone level. The above result applies when an average of one cycle is taken.

In the above, a change in the brightness, which is caused by forming each of the first coupling capacitance Cp1 and the second coupling capacitance Cp2 between the signal line S and the pixel electrode PE in an arbitrary frame period when red display is performed in the first display area A1, and halftone display is performed in the second to fifth display areas A2 to A5, has been described. However, the above similarly applies to a case where display of a color other than red is to be performed in the first display area A1.

FIG. 15 is a table showing a change in the brightness caused by the coupling capacitance formed between the signal line S and the pixel electrode PE when red display, green display, blue display, cyan display, magenta display, yellow display, white display, or black display is performed in the first display area A1, and halftone display is performed in the second to fifth display areas A2 to A5. More specifically, FIG. 15 shows a brightness of each of the pixels PX which are either positive or negative of the second display area A2 as compared to when the halftone display is performed in an arbitrary cycle, and the average brightness of the pixels PX of different colors of the second display area A2 as compared to when the halftone display is performed in the average of one cycle.

As shown in FIG. 15, while a case where the red display is performed in the first display area A1 is as shown in FIGS. 14A and 14B, also in cases where the green display, blue display, cyan display, magenta display, and yellow display are performed in the first display area A1, the brightness of the pixels PX can be changed by forming the first coupling capacitance Cp1 and the second coupling capacitance Cp2 in each of the pixels PX.

Note that even in a case where white color display or black color display is performed in the first display area A1, by setting the coupling capacitance to be Cp1=Cp2, the first coupling capacitance Cp1 and the second coupling capacitance Cp2 are mutually balanced out, and the halftone display can be maintained. Similarly, the halftone display can be maintained in the third display area A3.

When FIGS. 13 and 15 are compared, it can be understood that the pixel indicated as “bright” in FIG. 13 is indicated as “dim” in FIG. 15, whereas, the pixel indicated as “dim” in FIG. 13 is indicated as “bright” in FIG. 15, and that when a pixel is indicated as “−” in FIG. 13, that pixel is also indicated as “−” in FIG. 15. In view of the foregoing, since a change in the brightness level caused by the leakage electric field can be canceled by forming the first coupling capacitance Cp1 and the second coupling capacitance Cp2, vertical crosstalk can be suppressed. Further, it becomes possible to favorably perform the halftone display in a display area other than the first display area A1 such as the second display area A2, or to perform achromatic color display.

If the first coupling capacitance Cp1 and the second coupling capacitance Cp2 can be formed in each of the first to sixth pixels PX1 to PX6, as has been assumed above, the advantage of suppressing vertical crosstalk can further be obtained. However, even if the first coupling capacitance Cp1 and the second coupling capacitance Cp2 are not formed in all of the first to sixth pixels PX1 to PX6, the advantage of suppressing vertical crosstalk can be obtained.

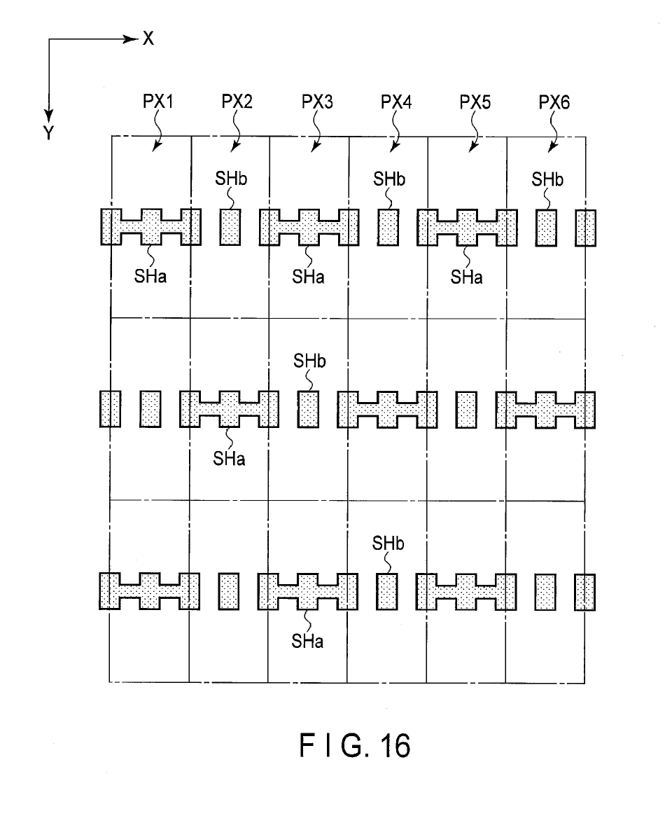

FIG. 16 is a plan view showing a part of the liquid crystal display panel PNL according to the first embodiment, and shows a pattern of the first light-shielding layer SHa and the second light-shielding layer SHb.

As shown in FIG. 16, in the present embodiment, with respect to the pixels PX arrayed in a matrix, the first light-shielding layer SHa and the second light-shielding layer SHb are arranged in a checkered pattern. If the first light-shielding layer SHa and the second light-shielding layer SHb are arranged in this way, since a change in the brightness level caused by the leakage electric field can be canceled in the pixel PX which can use the first light-shielding layer SHa, vertical crosstalk can be suppressed.

According to the liquid crystal display device DSP of the first embodiment configured as described above, the liquid crystal display device DSP comprises the array substrate AR, the counter-substrate CT arranged to be opposed to the array substrate AR, the liquid crystal layer LQ held between the array substrate AR and the counter-substrate CT, a first main common electrode CAL, and a second main common electrode CAR. The array substrate AR includes the first light-shielding layer SHa having conductivity, the first switching element SW1, the first signal line S1 and the second signal line S2 which are spaced apart from each other and extending in parallel, and the first pixel electrode PE1 which is located between the first signal line S1 and the second signal line S2, extends in parallel to the first signal line S1 and the second signal line S2, and is electrically connected to the first signal line S1 via the first switching element SW1. The first main common electrode CAL and the second main common electrode CAR are both provided on the array substrate AR. The first main common electrode CAL is opposed to the first signal line S1 and extends along the first signal line S1, and the second main common electrode CAR is opposed to the second signal line S2 and extends along the second signal line S2.

The liquid crystal display device DSP adopts the column-inversion drive scheme. The driver which includes at least part of the signal line driving circuit SD, the driver circuit IC, and the control module CM provides, in a first display period, for example, a common driving signal to the first main common electrode CAL and the second main common electrode CAR, a first image signal having a first polarity (for example, positive polarity) to the first signal line S1, and a second image signal having a second polarity (for example, negative polarity) different from the first polarity to the second signal line S2. The driver provides, in a second display period which is after the first display period, a common driving signal to the first main common electrode CAL and the second main common electrode CAR, a first image signal having the second polarity to the first signal line S1, and a second image signal having the first polarity to the second signal line S2. Accordingly, while AC-driving the liquid crystal layer LQ, a reduction in power consumption can be achieved.

The pixels PX including the first pixel PX1 arranged in the same column along the first signal line S1 each comprises the switching element SW and the pixel electrode PE, and share the first signal line S1.

When the first main common electrode CAL and the second main common electrode CAR are provided on the array substrate AR likewise the first pixel electrode PE, an influence of the leakage electric field from the signal lines S is significant, and vertical crosstalk, etc., is likely to occur. As a result, each of the first pixel electrode PE1, the first main common electrode CAL, and the second main common electrode CAR is provided on the array substrate AR (the first substrate) and arranged on the fourth insulating film 14. Thus, they are arranged on the same layer. Here, in the present embodiment, the first signal line S1 forms the first electrostatic capacitive coupling with the first light-shielding layer SHa, the second signal line S2 forms the second electrostatic capacitive coupling with the first light-shielding layer SHa, and the first pixel electrode PE1 forms the third electrostatic capacitive coupling with the first light-shielding layer SHa. That is, in the first pixel PX1, the first coupling capacitance Cp1 and the second coupling capacitance Cp2 are formed. Consequently, occurrence of vertical crosstalk can be suppressed. It is preferable that Cp1 be equal to Cp2.

Also, since it is possible to reduce occurrence of vertical crosstalk without needing to enhance an electric field shielding effect by increasing the width of the first main common electrode CAL and the second main common electrode CAR, for example, the aperture ratio can be prevented from being reduced.

Further, according to the present embodiment, the main common electrodes CA are opposed to the signal lines S, respectively. In particular, when the first main common electrode CAL and the second main common electrode CAR are disposed right above the first signal line S1 and the second signal line S2, respectively, apertures can be more increased as compared to a case where the first main common electrode CAL and the second main common electrode CAR are located closer to the first pixel electrode PE1 than from the first signal line S1 and the second signal line S2. Consequently, the light transmissivity of the first pixel PX1 can be improved.

By arranging the main common electrode CAL and the main common electrode CAR right above the first signal line S1 and the second signal line S2, respectively, a distance to the electrode, i.e., a distance between the pixel electrode PE and the main common electrode CAL, and between the pixel electrode PE and the main common electrode CAR can be increased, whereby a lateral electric field closer to a horizontal electric field can be produced. Therefore, achieving a wide viewing angle, which is the advantage of the IPS mode, etc., of a conventional structure, can be maintained. Also, the liquid crystal display device described above is excellent in its rapid response, and is also specialized in the alignment stability as described. Further, according to the present embodiment, a plurality of domains can be formed within one pixel. Accordingly, a viewing angle can be optically compensated in a plurality of directions, and achieving the wide viewing angle is enabled.

The first light-shielding layer SHa is opposed to both of at least the third regions R1c of the first semiconductor layer SC1 and at least the sixth region R2c of the second semiconductor layer at a distance, and shields these areas from light. The second light-shielding layer SHb shields at least the sixth region R2c of the second semiconductor layer from light. Consequently, it is possible to reduce a leakage current produced in the first switching element SW1 and the second switching element SW2 when the first switching element SW1 and the second switching element SW2 are turned off.

The first light-shielding layer SHa is arranged to be opposed to the scanning line G1, the first signal line S1, the second signal line S2, and the first pixel electrode PE1. The second light-shielding layer SHb is arranged to be opposed to the second pixel electrode PE2. Accordingly, it becomes possible to reduce the leakage current while preventing the apertures of the first and second pixels PX1 and PX2 from being reduced.

In view of the foregoing, in the first embodiment, a liquid crystal display device excellent in the display quality can be obtained.

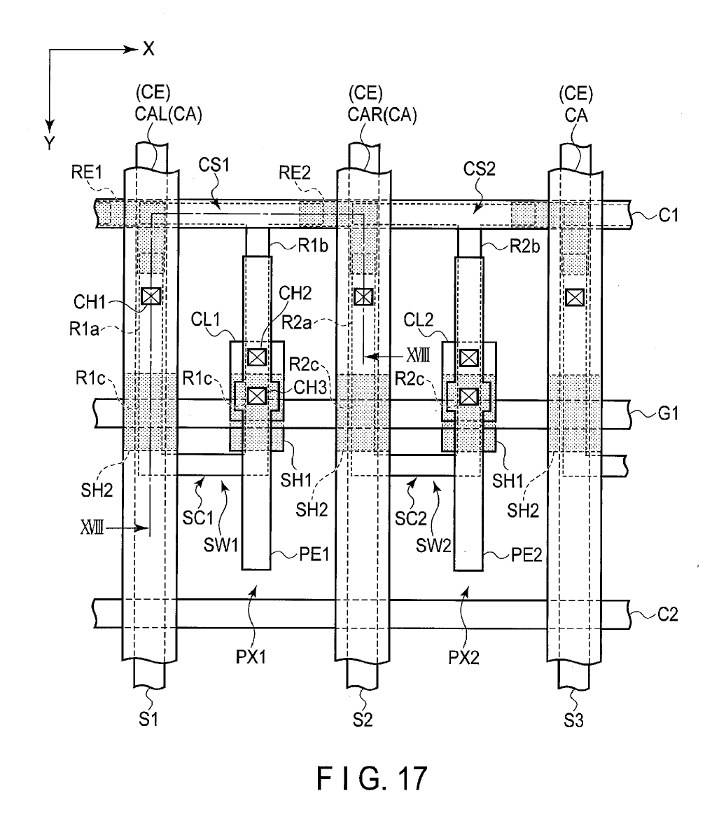

Next, a liquid crystal display device DSP according to a second embodiment will be described. FIG. 17 is a plan view showing two adjacent pixels PX1 and PX2 of a plurality of pixels PX of a liquid crystal display panel PNL according to the second embodiment.

As shown in FIG. 17, broadly, the second embodiment is distinguished from the first embodiment in that a first segment SH1 is electrically insulated from a second segment SH2 without involving a third segment SH3 to connect between the first segment SH1 and the second segment SH2, and that the liquid crystal display panel PNL further includes a first conductive layer RE1 and a second conductive layer RE2.

A auxiliary capacitance line C1 is opposed to the first conductive layer RE1 and the second conductive layer RE2. A first signal line S1 is opposed to the first conductive layer RE1, and a second signal line S2 is opposed to the second conductive layer RE2. In an X-Y planar view in which a main common electrode CAL is on the left side and a main common electrode CAR is on the right side, the first conductive layer RE1 and the second conductive layer RE2 are formed in the shape that letter L is reversed upside down, roughly. The first conductive layer RE1 extends in a first direction X along the auxiliary capacitance line C1, bends at an intersection of the auxiliary capacitance line C1 and the first signal line S1, and extends in a second direction Y along the first signal line S1. The first conductive layer RE1 is formed within an area which is opposed to the auxiliary capacitance line C1 and the first signal line S1. The second conductive layer RE2 extends in the first direction X along the auxiliary capacitance line C1, bends at an intersection of the auxiliary capacitance line C1 and the second signal line S2, and extends in the second direction Y along the second signal line S2. The second conductive layer RE2 is formed within an area which is opposed to the auxiliary capacitance line C1 and the second signal line S2.

In an area which is opposed to the auxiliary capacitance line C1, the first conductive layer RE1 is opposed to a second region R1b, and the second conductive layer RE2 is opposed to each of the second region R1b and a fifth region R2b. In an area which is opposed to the first signal line S1, the first conductive layer RE1 is opposed to each of a first region R1a and the second region R1b. In an area which is opposed to the second signal line S2, the second conductive layer RE2 is opposed to each of a fourth region R2a and the fifth region R2b. The first conductive layer RE1 and the second conductive layer RE2 are formed of a metal as a conductive material.

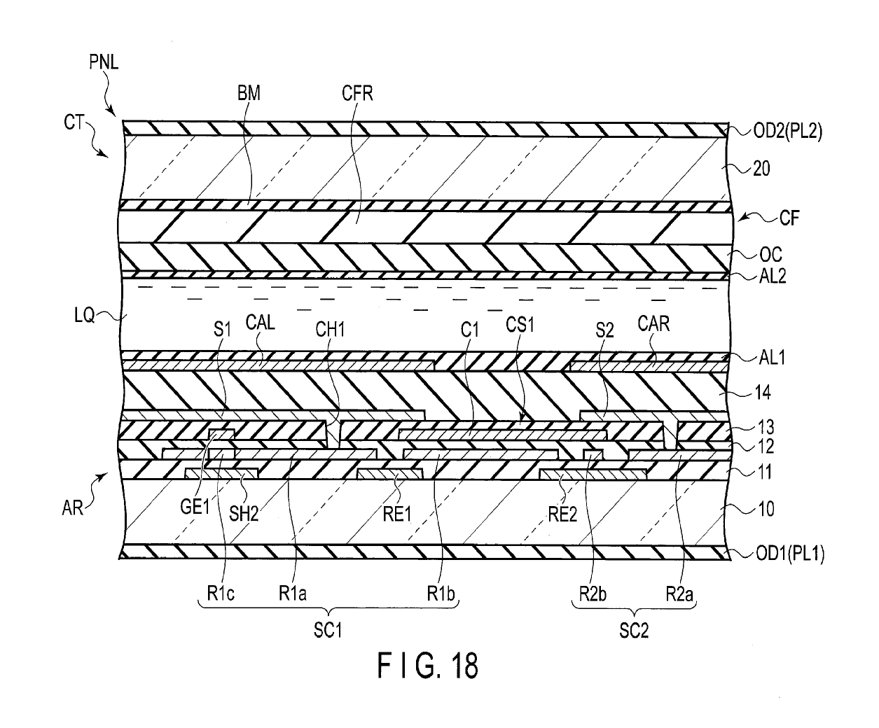

FIG. 18 is a cross-sectional view showing a part of the liquid crystal display panel PNL taken along line XVIII-XVIII of FIG. 17.

As shown in FIG. 18, the first conductive layer RE1 and the second conductive layer RE2 are formed in a layer of the same level as the first segment SH1 and the second segment SH2. For example, the first conductive layer RE1 and the second conductive layer RE2 are formed simultaneously with forming the first segment SH1 and the second segment SH2 by using the same material.

Since the first signal line S1 forms a first electrostatic capacitive coupling with the first conductive layer RE1, the first region R1a is opposed to the first conductive layer RE1 at a distance. Since the second signal line S2 forms a second electrostatic capacitive coupling with the second conductive layer RE2, the fourth region R2a is opposed to the second conductive layer RE2 at a distance. Since the first pixel electrode PE1 forms a third electrostatic capacitive coupling with the first conductive layer RE1, the second region R1b is opposed to the first conductive layer RE1 at a distance. Since the first pixel electrode PE1 forms a fourth electrostatic capacitive coupling with the second conductive layer RE2, the second region R1b is opposed to the second conductive layer RE2 at a distance.

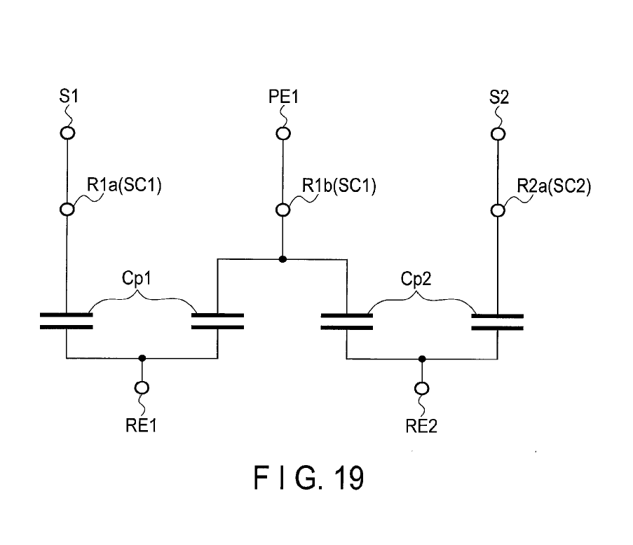

Next, a coupling capacitance according to the second embodiment which has been formed to suppress vertical crosstalk caused by a leakage electric field from signal lines S will be described. Also in the present embodiment, by forming the coupling capacitance and canceling a change in the brightness level by the leakage electric field, suppressing vertical crosstalk is enabled. FIG. 19 is an illustration for describing the state in which a first coupling capacitance Cp1 is formed between the first signal line S1 and the first pixel electrode PE1 shown in FIG. 17 by using the first conductive layer RE1, and a second coupling capacitance Cp2 is formed between the second signal line S2 and the first pixel electrode PE1 by using the second conductive layer RE2.

As shown in FIG. 19, the first coupling capacitance Cp1 includes a capacitance formed between the first region R1a and the first conductive layer RE1, and a capacitance formed between the second region R1b and the first conductive layer RE1. In other words, the first coupling capacitance Cp1 is formed of the above-described first electrostatic capacitive coupling and the third electrostatic capacitive coupling. The second coupling capacitance Cp2 includes a capacitance formed between the fourth region R2a and the second conductive layer RE2, and a capacitance formed between the second region R1b and the second conductive layer RE2. In other words, the second coupling capacitance Cp2 is formed of the above-described second electrostatic capacitive coupling and the fourth electrostatic capacitive coupling. It is preferable that various members for forming the first coupling capacitance Cp1, and various members for forming the second coupling capacitance Cp2 be arranged such that the relationship Cp1=Cp2 is satisfied. In the present embodiment, Cp1 is equal to Cp2. Further, the value of the first coupling capacitance Cp1 and the value of the second coupling capacitance Cp2 can be adjusted by changing the length of the first conductive layer RE1 and the second conductive layer RE2 in at least one of the first direction X and the second direction Y, for example.

Also, in the present second embodiment, since the first coupling capacitance Cp1 and the second coupling capacitance Cp2 can be formed in every pixel PX, a change in the brightness level caused by the leakage electric field can be canceled in all of the pixels PX. As a result, vertical crosstalk, etc., can be suppressed.

According to the liquid crystal display device DSP of the second embodiment configured as described above, the liquid crystal display device DSP comprises an array substrate AR, a counter-substrate CT arranged to be opposed to the array substrate AR, a liquid crystal layer LQ held between the array substrate AR and the counter-substrate CT, a first main common electrode CAL, and a second main common electrode CAR. The array substrate AR includes the first conductive layer RE1, the second conductive layer RE2, a first switching element SW1, the first signal line S1 and the second signal line S2 which are spaced apart from each other and extending in parallel, and the first pixel electrode PE1 which is located between the first signal line S1 and the second signal line S2, extends in parallel to the first signal line S1 and the second signal line S2, and is electrically connected to the first signal line S1 via the first switching element SW1. The first main common electrode CAL and the second main common electrode CAR are both provided on the array substrate AR. The first main common electrode CAL is opposed to the first signal line S1 and extends along the first signal line S1, and the second main common electrode CAR is opposed to the second signal line S2 and extends along the second signal line S2.

Also in the present embodiment, since a column-inversion drive scheme is adopted in the liquid crystal display device DSP, a reduction in power consumption can be achieved while AC-driving the liquid crystal layer LQ.

The first signal line S1 forms the first electrostatic capacitive coupling with the first conductive layer RE1, the second signal line S2 forms the second electrostatic capacitive coupling with the second conductive layer RE2, the first pixel electrode PE1 forms the third electrostatic capacitive coupling with the first conductive layer RE1, and the first pixel electrode PE1 forms the fourth electrostatic capacitive coupling with the second conductive layer RE2. That is, in the first pixel PX1, etc., the first coupling capacitance Cp1 and the second coupling capacitance Cp2 are formed. Consequently, occurrence of vertical crosstalk can be suppressed. It is preferable that Cp1 be equal to Cp2.

The first conductive layer RE1 is arranged to be opposed to the auxiliary capacitance line C1 and the first signal line S1, and the second conductive layer RE2 is arranged to be opposed to the auxiliary capacitance line C1 and the second signal line S2. Accordingly, it becomes possible to suppress occurrence of vertical crosstalk while preventing apertures of the first and second pixels PX1 and PX2 from being reduced.

In view of the foregoing, also in the second embodiment, a liquid crystal display device excellent in the display quality can be obtained.

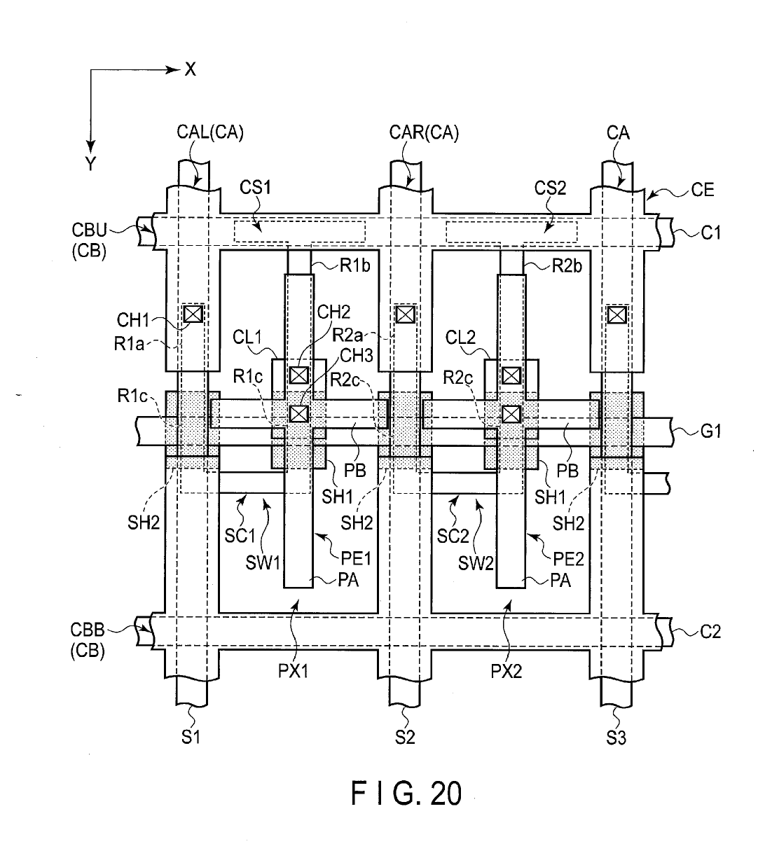

Next, a liquid crystal display device DSP according to a third embodiment will be described. FIG. 20 is a plan view showing two adjacent pixels PX1 and PX2 of a plurality of pixels PX of a liquid crystal display panel PNL according to the third embodiment.

As shown in FIG. 20, broadly, the third embodiment is distinguished from the first embodiment in that a first segment SH1 is electrically insulated from a second segment SH2 without involving a third segment SH3 to connect between the first segment SH1 and the second segment SH2, and in the form of a pixel electrode PE and a common electrode CE.

The common electrode CE further includes a plurality of sub-common electrodes CB. In the third embodiment, the sub-common electrodes CB are formed on the side of an array substrate AR. The sub-common electrodes CB are formed integrally or contiguously with a main common electrode CA. In the present embodiment, the sub-common electrodes CB are arranged on the same layer as the main common electrode CA, and formed integrally with the main common electrode CA. The sub-common electrodes CB are electrically connected to the main common electrode CA. The sub-common electrodes CB are arranged to be spaced apart from each other in a second direction Y, and a plurality of pixel electrodes PE are interposed therebetween in the second direction Y. Each of the sub-common electrodes CB extends in a first direction X. A common driving signal is provided to the main common electrode CA and the sub-common electrode CB.

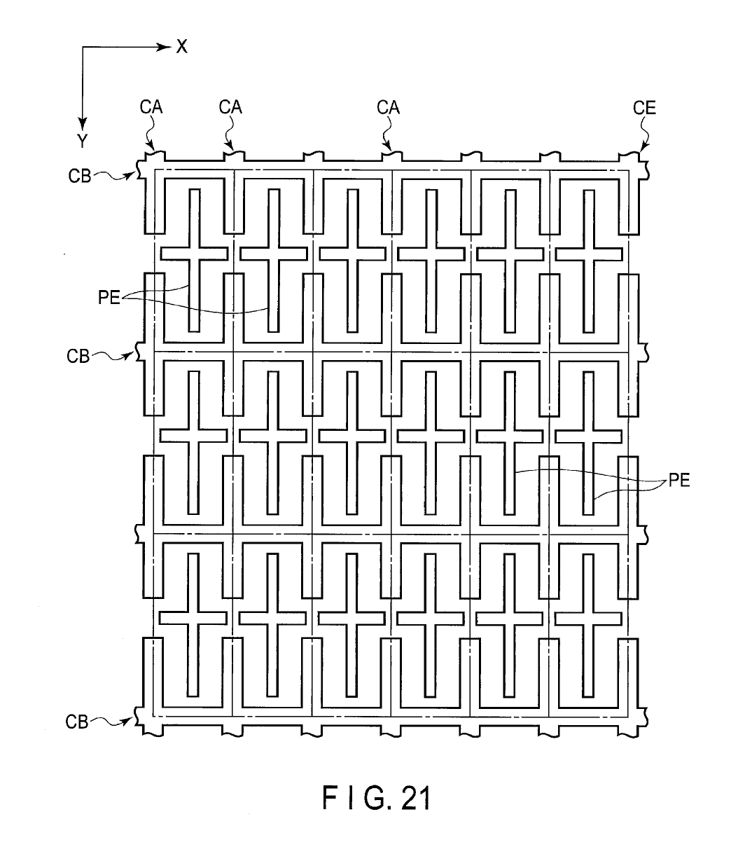

Each of the pixel electrodes PE is formed in a cross shape, and the common electrode CE is formed in a lattice shape such that each pixel PX is surrounded. In order to secure an insulation distance between the pixel electrode PE and the common electrode CE, the main common electrode CA extends in the second direction, and is formed of a plurality of segments aligned at intervals in the second direction. Note that the pixel electrode PE and the common electrode CE are patterned as shown in FIG. 21.

The pixel electrode PE comprises a main pixel electrode PA and a sub-pixel electrode PB which are electrically connected to each other. The main pixel electrode PA extends substantially linearly in the second direction Y from the sub-pixel electrode PB to the vicinity of an upper end portion of the pixel PX, and to the vicinity of a lower end portion of the same. The sub-pixel electrode PB extends in the first direction X. The sub-pixel electrode PB is located at an area which is opposed to a scanning line G1. In the example illustrated, the sub-pixel electrode PB is provided at a substantially central portion of the pixel PX.

The sub-common electrodes CB are opposed to auxiliary capacitance lines C, respectively. In the example illustrated, two sub-common electrodes CB are aligned in parallel in the first direction X. In the following, in order to distinguish between these two sub-common electrodes CB, the upper sub-common electrode in the drawing will be referred to as CBU, and the lower sub-common electrode in the drawing will be referred to as CBB. The sub-common electrode CBU is disposed at the upper end portion of the pixels PX1 and PX2, and is opposed to a auxiliary capacitance line C1. That is, the sub-pixel electrode CBU is disposed to extend over a boundary between the pixels mentioned above and pixels neighboring on the upper side. Further, the sub-common electrode CBB is disposed at the lower end portion of the pixels PX1 and PX2, and is opposed to a auxiliary capacitance line C2. That is, the sub-pixel electrode CBB is disposed to extend over a boundary between the pixels mentioned above and pixels neighboring on the lower side.

As can be seen, in each of the pixels PX, in a state in which an electric field is produced between the pixel electrode PE and the common electrode CE, electric fields that are different from one another can be made to act in four domains. Accordingly, not only a viewing angle can be widened, but also the alignment restriction force of liquid crystal molecules LM can be increased as compared to a pixel structure shown in FIG. 5.

Next, a coupling capacitance according to the third embodiment which has been formed to suppress vertical crosstalk caused by a leakage electric field from signal lines S will be described. Also in the present embodiment, by forming the coupling capacitance and canceling a change in the brightness level by the leakage electric field, suppressing vertical crosstalk is enabled.

A first coupling capacitance Cp1 includes a capacitance formed between the sub-pixel electrode PB and a first signal line S1. In other words, the first coupling capacitance Cp1 is formed as the sub-pixel electrode PB forms a first electrostatic capacitive coupling with the first signal line S1. A second coupling capacitance Cp2 includes a capacitance formed between the sub-pixel electrode PB and a second signal line S2. In other words, the second coupling capacitance Cp2 is formed as the sub-pixel electrode PB forms a second electrostatic capacitive coupling with the second signal line S2. It is preferable that various members for forming the first coupling capacitance Cp1, and various members for forming the second coupling capacitance Cp2 be arranged such that the relationship Cp1=Cp2 is satisfied. In the present embodiment, Cp1 is equal to Cp2. Further, the value of the first coupling capacitance Cp1 and the value of the second coupling capacitance Cp2 can be adjusted by changing the width of the sub-pixel electrode PB, or the proximity of the sub-pixel electrode PB to the signal lines S.

In addition, in the present third embodiment, since the first coupling capacitance Cp1 and the second coupling capacitance Cp2 can be formed in every pixel PX, a change in the brightness level caused by the leakage electric field can be canceled in all of the pixels PX. As a result, vertical crosstalk, etc., can be suppressed.

According to the liquid crystal display device DSP of the third embodiment configured as described above, the first coupling capacitance Cp1 and the second coupling capacitance Cp2 can be formed in every pixel PX. Accordingly, as in the above-described embodiments, occurrence of vertical crosstalk can be suppressed.

In view of the foregoing, also in the third embodiment, a liquid crystal display device excellent in the display quality can be obtained.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

The common electrode CE may be provided on at least one of the substrates of the array substrate AR and the counter-substrate CT. For example, the common electrode CE may be provided on only the side of the counter-substrate CT. Alternatively, the common electrode CE may comprise not only main common electrodes CA provided on the array substrate AR, but also the other main common electrodes which are provided on the counter-substrate CT and are opposed to the main common electrode CA (or the signal lines S).

Each of the switching elements SW may be formed of a single-gate thin-film transistor, instead of a double-gate thin-film transistor, or may be formed of a triple-gate thin-film transistor.

The driver according to the above-described embodiments is not limited to at least a part of the signal line driving circuit SD, the driver circuit IC, and the control module CM, and may be modified variously. It suffices that the driver can provide an image signal (for example, a video signal) to the signal lines S, or provide a common driving signal to the common electrode CE.

In the embodiments described above, the liquid crystal display device DSP has been disclosed by way of example. However, the above embodiments are applicable to the other liquid crystal display devices. Moreover, it is only natural that the above-described embodiments are applicable to display devices of small to middle sizes to even large-sizes, without any particular limitations.

What is claimed is:

1. A liquid crystal display device comprising:
a first substrate including: a conductive layer; a first switching element; a first signal line and a second signal line which extend to be spaced apart from each other, the first signal line forming a first electrostatic capacitive coupling with the conductive layer, the second signal line forming a second electrostatic capacitive coupling with the conductive layer; and a first pixel electrode which is located between the first signal line and the second signal line, is electrically connected to the first signal line via the first switching element, and forms a third electrostatic capacitive coupling with the conductive layer;
a second substrate arranged to be opposed to the first substrate;
a liquid crystal layer held between the first substrate and the second substrate; and
a first common electrode and a second common electrode both provided on at least one of the first substrate and the second substrate, the first common electrode being opposed to the first signal line and extending along the first signal line, the second common electrode being opposed to the second signal line and extending along the second signal line.

2. The liquid crystal display device of claim 1, wherein:
the first substrate further includes a second switching element, and a second pixel electrode which is electrically connected to the second signal line via the second switching element;
the first switching element includes a first semiconductor layer, a first gate electrode which is located above the first semiconductor layer, and is arranged to be opposed to the first semiconductor layer, and a gate insulating film provided between the first semiconductor layer and the first gate electrode;
the second switching element includes a second semiconductor layer, a second gate electrode which is located above the second semiconductor layer, and is arranged to be opposed to the second semiconductor layer, and the gate insulating film provided between the second semiconductor layer and the second gate electrode; and
the conductive layer is located below the first semiconductor layer and the second semiconductor layer, is opposed to both of a third region, which is a part of the first semiconductor layer opposed to the first gate electrode, and a sixth region, which is a part of the second semiconductor layer opposed to the second gate electrode, at a distance, and has a light-shielding property.

3. The liquid crystal display device of claim 2, wherein:
the first semiconductor layer includes a first region, which is connected to the first signal line and set to have a same potential as the first signal line, a second region, which is connected to the first pixel electrode and set to have a same potential as the first pixel electrode, and the third region between the first region and the second region;
the second semiconductor layer includes a fourth region, which is connected to the second signal line and set to have a same potential as the second signal line, a fifth region, which is connected to the second pixel electrode and set to have a same potential as the second pixel electrode, and the sixth region between the fourth region and the fifth region;
the first region is opposed to the conductive layer at a distance to form the first electrostatic capacitive coupling;
the fourth region is opposed to the conductive layer at a distance to form the second electrostatic capacitive coupling; and
the second region is opposed to the conductive layer at a distance to form the third electrostatic capacitive coupling.

4. The liquid crystal display device of claim 3, wherein:
the first substrate further includes a scanning line which includes the first gate electrode and the second gate electrode, and extends in such a way that it crosses each of the first signal line and the second signal line; and
the conductive layer is arranged to be opposed to the scanning line, the first signal line, the second signal line, and the first pixel electrode.

5. The liquid crystal display device of claim 1, wherein each of the first common electrode and the second common electrode is provided on the first substrate, and is disposed on a same layer.

6. The liquid crystal display device of claim 1, further comprising:
a driver which is electrically connected to the first signal line, the second signal line, the first common electrode, and the second common electrode,
wherein the driver is configured to:
provide, in a first display period, a common driving signal to the first common electrode and the second common electrode, a first image signal having a first polarity to the first signal line, and a second image signal having a second polarity different from the first polarity to the second signal line; and
provide, in a second display period which is after the first display period, the common driving signal to the first common electrode and the second common electrode, the first image signal having the second polarity to the first signal line, and the second image signal having the first polarity to the second signal line.

7. The liquid crystal display device of claim 1, further comprising:
a plurality of pixels each comprising the first switching element and the first pixel electrode, the pixels arranged in a same column along the first signal line, wherein
the pixels share the first signal line.

8. A liquid crystal display device comprising:
a first substrate including: a first conductive layer; a second conductive layer; a first switching element; a first signal line and a second signal line which extend to be spaced apart from each other, the first signal line forming a first electrostatic capacitive coupling with the first conductive layer, the second signal line forming a second electrostatic capacitive coupling with the second conductive layer; and a first pixel electrode which is located between the first signal line and the second signal line, is electrically connected to the first signal line via the first switching element, forms a third electrostatic capacitive coupling with the first conductive layer, and forms a fourth electrostatic capacitive coupling with the second conductive layer;
a second substrate arranged to be opposed to the first substrate;
a liquid crystal layer held between the first substrate and the second substrate; and
a first common electrode and a second common electrode both provided on at least one of the first substrate and the second substrate, the first common electrode being opposed to the first signal line and extending along the first signal line, the second common electrode being opposed to the second signal line and extending along the second signal line.

9. The liquid crystal display device of claim 8, wherein:
the first substrate further includes a first light-shielding layer, a second light-shielding layer, a second switching element, and a second pixel electrode which is electrically connected to the second signal line via the second switching element;
the first switching element includes a first semiconductor layer, a first gate electrode which is located above the first semiconductor layer, and is arranged to be opposed to the first semiconductor layer, and a gate insulating film provided between the first semiconductor layer and the first gate electrode;
the second switching element includes a second semiconductor layer, a second gate electrode which is located above the second semiconductor layer, and is arranged to be opposed to the second semiconductor layer, and the gate insulating film provided between the second semiconductor layer and the second gate electrode;
the first light-shielding layer is located below the first semiconductor layer, and is opposed to a third region of the first semiconductor layer which is opposed to the first gate electrode at a distance; and
the second light-shielding layer is located below the second semiconductor layer, and is opposed to a sixth region of the second semiconductor layer which is opposed to the second gate electrode at a distance.

10. The liquid crystal display device of claim 9, wherein:
the first semiconductor layer includes a first region, which is connected to the first signal line and set to have a same potential as the first signal line, a second region, which is connected to the first pixel electrode and set to have a same potential as the first pixel electrode, and the third region between the first region and the second region;
the second semiconductor layer includes a fourth region, which is connected to the second signal line and set to have a same potential as the second signal line, a fifth region, which is connected to the second pixel electrode and set to have a same potential as the second pixel electrode, and the sixth region between the fourth region and the fifth region;
the first region is opposed to the first conductive layer at a distance to form the first electrostatic capacitive coupling;
the fourth region is opposed to the second conductive layer at a distance to form the second electrostatic capacitive coupling; and
the second region is opposed to the first conductive layer at a distance to form the third electrostatic capacitive coupling; and
the second region is opposed to the second conductive layer at a distance to form the fourth electrostatic capacitive coupling.

11. The liquid crystal display device of claim 10, wherein:
the first substrate further includes a auxiliary capacitance line which extends in such a way that it crosses each of the first signal line and the second signal line, and forms an electrostatic capacitive coupling with each of the first pixel electrode and the second pixel electrode;
the first conductive layer is arranged to be opposed to the auxiliary capacitance line and the first signal line; and
the second conductive layer is arranged to be opposed to the auxiliary capacitance line and the second signal line.

12. The liquid crystal display device of claim 9, wherein the first conductive layer, the second conductive layer, the first light-shielding layer, and the second light-shielding layer are formed of a same material in a layer of a same level.

13. The liquid crystal display device of claim 8, wherein each of the first common electrode and the second common electrode is provided on the first substrate, and is disposed on a same layer.

14. The liquid crystal display device of claim 8, further comprising:
a driver which is electrically connected to the first signal line, the second signal line, the first common electrode, and the second common electrode,
wherein the driver is configured to:
provide, in a first display period, a common driving signal to the first common electrode and the second common electrode, a first image signal having a first polarity to the first signal line, and a second image signal having a second polarity different from the first polarity to the second signal line; and
provide, in a second display period which is after the first display period, the common driving signal to the first common electrode and the second common electrode, the first image signal having the second polarity to the first signal line, and the second image signal having the first polarity to the second signal line.

15. The liquid crystal display device of claim 8, further comprising:
a plurality of pixels each comprising the first switching element and the first pixel electrode, the pixels arranged in a same column along the first signal line, wherein
the pixels share the first signal line.

16. A liquid crystal display comprising:
an insulating substrate;
a first scanning line on the insulating substrate;
a first signal line and a second signal line which cross the first scanning line;
a first switching element which is electrically connected to the first scanning line and the first signal line, and comprises a first gate electrode and a second gate electrode;
a second switching element which is electrically connected to the first scanning line and the second signal line, and comprises a third gate electrode and a fourth gate electrode;
a first light-shielding layer which overlaps the first gate electrode, the second gate electrode, and the third gate electrode, and is formed in a body; and
a second light-shielding layer which overlaps the fourth gate electrode, and is not connected to the first light-shielding layer.

17. The liquid crystal display device of claim 16, wherein:
the first gate electrode overlaps the first signal line; and
the third gate electrode overlaps the second signal line.

18. The liquid crystal display device of claim 16, further comprising:
a second scanning line which crosses the first signal line and the second signal line;
a third switching element which is electrically connected to the second scanning line and the first signal line, and comprises a fifth gate electrode and a sixth gate electrode;
a fourth switching element which is electrically connected to the second scanning line and the second signal line, and comprises a seventh gate electrode and an eighth gate electrode;
a third light-shielding layer which overlaps the fifth gate electrode;
a fourth light-shielding layer which overlaps the sixth gate electrode, and is not connected to the third light-shielding layer; and
a fifth light-shielding layer which overlaps the seventh electrode and the eighth gate electrode, and is formed in a body, wherein
the fifth light-shielding layer is not connected to the fourth light-shielding layer.

19. The liquid crystal display device of claim 16, wherein the first and second light-shielding layers are formed between the insulating substrate and the first scanning line.

20. The liquid crystal display device of claim 18, wherein the first to fifth light-shielding layers are formed between the insulating substrate and scanning lines including the first and second scanning lines.
